(19) United States
(12) Patent Application Publication
(10) Pub. No.: US 2023/0289968 A1
(43) Pub. Date: Sep. 14, 2023

(54) AUTOMATED ANALYSIS OF CELL CULTURES

(71) Applicant: Hoffmann-La Roche Inc., Little Falls, NJ (US)

(72) Inventors: Eugenio MARTINELLI, Rome (IT); Arianna MENCATTINI, Rome (IT); Maria Carla PARRINI, Paris (FR); Irina VEITH, Paris (FR)

(21) Appl. No.: 18/023,682

(22) PCT Filed: Aug. 20, 2021
(86) PCT No.: PCT/EP2021/073200

§ 371 Date: Feb. 27, 2023

(30) Foreign Application Priority Data
Sep. 8, 2020 (EP) 20305990.2

(51) Int. Cl. G06T 7/00; G06T 7/70; G06T 7/11; G06T 7/194

(52) U.S. Cl. CPC G06T 7/0016; G06T 7/11; G06T 7/194; G06T 7/70; G06T 2207/10056; G06T 2207/10064; G06T 2207/20036; G06T 2207/30024

(57) ABSTRACT

The present invention provides a computer-implemented method for analysing cell culture image data, in particular for analysing the spatiotemporal behaviour of the occurrence of a cellular event in a cell culture. The method comprise obtaining image data comprising a set of images of the cell culture at a plurality of consecutive time points, using an image analysis algorithm to determine the position of cells in at least a first population of cells in each of the images, linking at least some of the positions of cells in the images into respective cell tracks, and identifying the timing and position of occurrence of a cellular event in each of a plurality of cell tracks. The method may also comprise obtaining a spatiotemporal map of the events that have been identified, and quantifying the spatiotemporal pattern of occurrence of the event.

### FIELD OF THE INVENTION

The present invention relates in part to methods for automated analysis of cell cultures by analysing image data series from the culture, including automated, spatial and time-resolved quantification of apoptosis. An associated system, computer readable medium and software products are also disclosed.

### BACKGROUND TO THE INVENTION

Recent advances in microfluidics and microfabrication inspired new solutions to reproduce 3D microarchitectures ex vivo, which imitate characteristics of organ functional units and of tumor microenvironments. When provided in the context of microfluidics chips, this technology is referred to as “organ-on-chip” (OoC) [1-3] and “tumor-on-chip” (ToC) [4-6]. The OoC/ToC technology offers numerous advantages, such as tight control of physicochemical and biological conditions (cell types, 3D biomimetic hydrogel, biochemical environment), real-time observation of cellular dynamics, miniaturization (few cells and little reagent are needed), fast results, and low costs. For example, the present inventors previously demonstrated that it is feasible to reconstitute and visualize on-chip various tumor ecosystems, composed of up to four cell types (cancer cells, immune cells, cancer-associated fibroblasts, and endothelial cells). These tumor ecosystems could be treated with various anti-cancer drugs, including standard chemotherapies and targeted therapies (e.g., trastuzumab) [7,8,37]. The videos enabled the visualization and quantification of proliferation (by manually counting mitosis events), apoptosis (by manually counting apoptotic death of cells) and cancer-immune cell interactions (by tracking cells using the CellHunter tracking method [32] and identifying intervals of time where cells are within a distance from each other), upon these various treatments. The present inventors further demonstrated the potential for a deep learning approach to be applied to time-lapse microscopy images of ToCs to analyze cell motility [37], and detect the effect of anti-cancer drugs on cell motility.

Despite this huge potential, so far, the ToC use has been restrained to specialized laboratories and has not reached the broad community of cancer researchers. Several promising applications in basic and translational research, as well as in clinics, have been proposed, but their implementation clearly requires further development. In particular, a major bottleneck for the take-off of ToC technology is the lack of computer tools to process, analyze, and fully exploit the rich information generated by ToC imaging.

The present invention seeks to provide solutions to these needs and provides further related advantages.

### BRIEF DESCRIPTION OF THE INVENTION

The present inventors set out to develop and validate a novel computational method to automatically extract the temporal kinetics and the spatial maps of cell death (particularly cancer cell death) in ToC cultures. The integration of advanced image analysis tools and methods to quantify apoptosis events from the data produced by image analysis tools provides a new powerful solution to the problem of leveraging the rich data coming out of OoC/ToC experiments to derive useful insights, and enable future OoC/ToC applications in high-throughput drug screenings.

Accordingly, in a first aspect the present invention provides a computer-implemented method for analysing cell culture image data, the method comprising:
accessing image data comprising a set of images (V(x,y,t)) of a cell culture at a plurality of consecutive time points (t= 1,..,T), wherein the image data comprises a first signal associated with the presence of cells and a second signal associated with the occurrence of a cellular event;
using an image analysis algorithm to determine the position of cells in at least a first population of cells ((x_{tc}(t),y_{tc}(t)), from the first signal, in each of the images (V(x,y,t));
linking at least some of the positions of cells in the images into respective cell tracks, wherein a cell track identifies the position of a single cell ((x_{tc}(t),y_{tc}(t),
$$\left(t = \left\{{t}_{t c}^{s t a r t} , … , {t}_{t c}^{e n d}\right\}\right)$$
in a plurality of consecutive images (V(x,y,t),
$$\left(t = \left\{{t}_{t c}^{s t a r t} , … , {t}_{t c}^{e n d}\right\}\right)$$
of the set of images;
identifying the timing
$$\left({T}_{t c}^{d e a t h}\right)$$
and position
$$\left({x}_{t c} \left({T}_{t c}^{d e a t h}\right) , {y}_{t c} \left({T}_{t c}^{d e a t h}\right)\right)$$
of occurrence of a cellular event in each of a plurality of cell tracks by:
(i) quantifying the second signal associated with the cell (µ_{tc}(t)) in each image in which the respective cell track is present;
(ii) obtaining a criterion that applies to the values in (i) and is associated with the occurrence of the cellular event; and
(iii) identify the timing
$$\left({T}_{t c}^{d e a t h}\right)$$
of occurrence of the cellular event in each of the plurality of cell tracks as the time associated with the first image in the respective track where the value obtained in (i) satisfies the criterion in (ii), and the position
$$\left({x}_{t c} \left({T}_{t c}^{d e a t h}\right) , {y}_{t c} \left({T}_{t c}^{d e a t h}\right)\right)$$
of occurrence of the cellular event as the position
$$\left({x}_{t c} \left({T}_{t c}^{d e a t h}\right) , {y}_{t c} \left({T}_{t c}^{d e a t h}\right)\right)$$
of the cell at the time of occurrence of the cellular event.

As a result of this method, the occurrence of a particular cellular event of interest is detected for each single cell that is identified and tracked through the sequence of images of the cell culture. Prior art methods have been proposed that track cells across consecutive images for example for the purpose of studying cell motility. Other methods have been proposed that quantify the global proportions of cells in which a cellular event has occurred over time. The present method integrates both of these types of information by detecting the occurrence of cellular events in cell tracks, thereby providing spatially and temporally resolved information that enables to study the effect that cells undergoing particular cellular events have on each other, as well as the impact of various factors on these effects.

In accordance with this and other aspects of the invention, the method may further comprise any of the following features.

An image may be referred to herein as a “frame”. A set of images may be referred to herein as a video or time-lapse video. Each image or frame is associated with a time t. Images are preferably two dimensional images. A set of images may also be represented as a set of data points where each point (x,y,t) represents a pixel at position (x,y) at time t((x, y,t) ∈ {1,..,D₁}×{1,..D₂}×{1,..T} ) . Each data point may be associated with a first value (I_{RED}(x,y,t)) associated with a first channel and a second value (I_{GREEN}(x,y,t)) associated with a second channel. The data from the first channel may together form a first signal. The data from the second channel may together form a second signal.

The plurality of consecutive time points may be separated by a fixed time interval such as e.g. 1 hour. The length of the fixed time interval may be chosen depending on the expected dynamics of the cellular event(s) that is/are monitored and/or on practical considerations related to image acquisition and/or processing. As the skilled person understands, where the plurality of consecutive time points is separated by a fixed time interval, the values of time t may be referred to as consecutive integers 1,...T where T is the total number of images in a set of images (such as e.g. the number of frames in a time lapse video).

As will be explained further below, a first signal associated with the presence of cells and a second signal associated with the occurrence of a cellular event may be obtained from a common channel. Further, first and second signals may be associated with a common label, but different sets of visual features. For example, a signal associated with the occurrence of a cellular event may be associated with a label that labels cells whether or not the cellular event has occurred, but where the intensity and/or spatial features of the signal changes in a detectable manner upon occurrence of the cellular event.

Step (i) may comprise identifying a foreground region (R_{F}(x_{tc}(t),y_{tc}(t))) and a background region (R_{B}(x_{tc}(t),y_{tc}(t))) associated with each cell position in a respective track ((x_{tc}(t),y_{tc}(t),

$$\left(t = \left\{{t}_{t c}^{s t a r t} , … , {t}_{t c}^{e n d}\right\}\right) .$$

The foreground region and the background region may each be centred around each cell position in a respective track. Step (i) may further comprise quantifying the second signal in the foreground region

$$\left({μ}_{t c}^{{R}_{F}} \left(t\right)\right)$$

and in the background region

$$\left({μ}_{t c}^{{R}_{B}} \left(t\right)\right) ,$$

and quantifying the second signal associated with the cell by performing background subtraction. Quantifying the second signal in the foreground and the background region may comprise obtaining a summarised metric for the second signal over the respective region.

Advantageously, the quantification of the second signal using background correction enables to remove potentially misleading signal resulting from background noise or other cells in the vicinity, thereby obtaining a signal that is more likely to be specific to the particular cell under investigation.

In embodiments, the summarised metric is chosen from: the average, median, trimmed average, trimmed median, a predetermined percentile and a predetermined quartile for the second signal over the respective region.

In embodiments, the image analysis algorithm used to determine the position of cells in at least a first population of cells ((x_{tc}(t),y_{tc}(t)), from the first signal, in each of the images (V(x,y,t)) also determines a radius r associated with each cell.

In embodiments, the foreground region is defined as a circular region centred around the position of the cell ((x_{tc}(t),y_{tc}(t))] and with a radius r_{F}. The radius r_{F} may be that determined by the image analysis algorithm or may be a predetermined radius. A predetermined radius may be chosen as the expected radius for the cell, which may be determined from prior knowledge or as an empirical estimate (such as e.g. the average radius of cells in the first population of cells in the image data).

In embodiments, the foreground region is defined as a region identified by the image analysis algorithm as corresponding to a cell.

The background region may be defined as a circular region centred around the position of the cell ((x_{tc}(t),y_{tc}(t))] and with a radius r_{B}. The radius r_{B} may be defined as a multiple of the value of r_{F} (e.g. 1.5, 2, 2.5, 3, 3.5, 4, 4.5, 5, 6, 7, 8, 9 or 10 times r_{F}). Alternatively, the radius r_{B} may be a predetermined radius. A predetermined radius may be chosen as a multiple (.g. 1.5, 2, 2.5, 3, 3.5, 4, 4.5, 5, 6, 7, 8, 9 or 10 times) of the expected radius for the cell, which may be determined from prior knowledge or as an empirical estimate (such as e.g. the average radius of cells in the first population of cells in the image data).

Quantifying the second signal associated with the cell may further comprise performing background normalisation. Performing background normalisation may comprise dividing the (optionally summarised) value for the foreground region (optionally after background subtraction) by the (optionally summarised) value for the background region.

Quantifying the second signal associated with the cell (µ_{tc}(t)) in each image in which the respective cell track is present may comprise performing background subtraction and normalisation to obtain a corrected value for each time point at which the cell track has been identified, and subtracting from the corrected value the minimum corrected value identified in the respective track. As a result of this process, a corrected value is obtained for each time point of a cell track, which is 0 where the corrected signal is at its lowest value for the track, and takes positive values at all other time points. This advantageously results in a population of values (µ_{tc}(t)) for all time points in cell tracks that are comparable to each other.

Quantifying the second signal associated with the cell (µ_{tc}(t)) in each image in which the respective cell track is present may comprise calculating µ_{tc}(t) as:

$${μ}_{t c} \left(t\right) = \frac{{μ}_{t c}^{{R}_{F}} \left(t\right) - {μ}_{t c}^{{R}_{B}} \left(t\right)}{{μ}_{t c}^{{R}_{B}} \left(t\right)} - {min}_{\hat{t} ∈ \left\{{t}_{t c}^{s t a r t} , … , {t}_{t c}^{e n d}\right\}} \left(\frac{{μ}_{t c}^{{R}_{F}} \left(\hat{t}\right) - {μ}_{t c}^{{R}_{B}} \left(\hat{t}\right)}{{μ}_{t c}^{{R}_{B}} \left(\hat{t}\right)}\right)$$

where

$${t}_{t c}^{s t a r t} \text{and} {t}_{t c}^{e n d}$$

refer to the first and last time point, respectively, in which the cell track has been identified.

The first signal may be associated with a first channel. The second signal may be associated with a second channel, which may be different from the first channel. The first and second channels may be associated with different visualisation protocols, such as e.g. different detection wavelengths or sets/ranges of detection wavelengths.

In embodiments, the first signal and the second signal are associated with a common channel, the first signal comprises a first set of visual features associated with the presence of cells and the second signal comprises a second set of visual features associated with the occurrence of a cellular event.

Image analysis algorithms that are suitable to identify regions in an image associated with a signal of interest (a task sometimes referred to as “segmentation” or “object detection”) are known in the art. Such algorithms may include Circular Hough Transform (CHT), deep learning algorithms such as convolutional neuronal networks, semantic segmentation based on deep learning architectures, Watershed segmentation, etc. The position of a cell may be obtained from such algorithms as a parameter of the corresponding region, such as e.g. as the centre or the centre of mass of the region.

In embodiments, using an image analysis algorithm to determine the position of cells in at least a first population of cells ((x_{tc}(t),y_{tc}(t)), from the first signal, in each of the images (V(x,y,t)) comprises using a Circular Hough Transform (CHT) to identify circular regions corresponding to cells.

The method may further comprise binarising the first signal prior to using the image analysis algorithm. Binarising the first signal may comprise identifying a threshold on pixel intensity associated with the first signal, where the threshold separates pixels into two classes, minimizing the intra-class variance. Any pixel with an intensity below the threshold may then be set to a first value (e.g. 0), and any pixel with an intensity at or above the threshold may then be set to a second value (e.g. 1).

Identifying the timing

$$\left({T}_{t c}^{d e a t h}\right)$$

and position

$$\left({x}_{t c} \left({T}_{t c}^{d e a t h}\right) , {y}_{t c} \left({T}_{t c}^{d e a t h}\right)\right)$$

of occurrence of a cellular event in each of a plurality of cell tracks may comprise, for each of the plurality of cell tracks and each of the time points in which the respective cell track has been identified: defining a region of interest R(x_{tc}(t),y_{tc}(t)) including the previous position of the cell in the track, and defining the foreground region (R_{F}(x_{tc}(t),y_{tc}(t))) and the background region (R_{B}(x_{tc}(t),y_{tc}(t))) as subsets of the region of interest. The region of interest may be circular, square, rectangular, octagonal, hexagonal, etc. Preferably, the region of interest is square.. The region of interest may be centred on the previous position of the cell in the track. The foreground region (R_{F}(x_{tc}(t),y_{tc}(t))) and the background region (R_{B}(x_{tc}(t),y_{tc}(t))) may both be centred around each cell position in a respective track ((x_{tc}(t),y_{tc}(t),

$$\left(t = \left\{{t}_{t c}^{s t a r t} , … , {t}_{t c}^{e n d}\right\}\right) .$$

The foreground region and the background region may both be circular. Alternatively, the foreground region may be circular and the background region may have the shape of the region of interest excluding the foreground region. The foreground and background regions may have respective radii corresponding to the expected (e.g. average) radius of the cell and a multiple (e.g. double) the expected radius of the cell.

A region of interest may be defined as a region of n by m pixels centred around a previously determined cell position, where n may be the same as m (square region) or different (rectangular region). The values of n and m may be chosen such that the region of interest corresponds to an area that is large enough to show an entire cell. For example, the values of n and m may be chosen such that the region of interest corresponds to an area of between 10 µm to a few hundred µm, e.g. between 10 µm and 200 µm, such as e.g. approx. 20 µm.

The use of a region of interest to obtain updated coordinates for each cell may advantageously result in more accurate estimates of the second signal associated with each cell by limiting the effect of confounding factors such as e.g. those associated with surrounding cells.

Obtaining a criterion that applies to the values in (i) may comprise receiving a threshold from a user or retrieving a predetermined threshold, wherein cells in which the cellular event has occurred have a value in (ii) above the threshold.

Obtaining a criterion that applies to the values in (i) may comprise identifying a threshold that separates the distribution of values of the second signal for the cells across the plurality of cell tracks between a first subset and a second subset such that the intrasubset variance is minimised.

Obtaining a criterion that applies to the values in (i) may comprise determining a threshold that separates the distribution of values of the second signal for the cells across the plurality of cell tracks between a first subset and a second subset such that the intersubset variance is maximised.

Obtaining a criterion that applies to the values in (i) may comprise identifying at least a first subset of the distribution of values of the second signal for the cells across the plurality of cell tracks, and a second subset of the distribution of values of the second signal, wherein the first subset corresponds to cells in which the cellular event has not occurred, and the second subset corresponds to cells in which the cellular event has occurred, and the criterion is that the value obtained in (i) is more likely to be in the second subset of the distribution of values of the second signal identified in (ii) than in the first subset of the distribution of values of the second signal identified in (i).

Step (ii) may comprise identifying a threshold (th) that separates the values of the second signal for the cells between two classes such that the intra-class variance is minimised. Step (iii) may comprise identifying the first image in the respective track where the value obtained in (i) is above the threshold.

In particular, the timing of death may be identified as

$${T}_{t c}^{d e a t h} = {min}_{t} \left\{t ∈ \left\{{t}_{t c}^{s t a r t} , … , {t}_{t c}^{e n d}\right\} \vert {μ}_{t c} \left(t\right) > t h\right\} .$$

Such embodiments are particularly advantageous where occurrence of the cellular event is associated with an increase in the value of the second signal, such as e.g. where the second signal is associated with an event-triggered label. In other embodiments, step (iii) comprises identifying the first image in the respective track where the value obtained in (i) is below the threshold. Such embodiments are particularly advantageous where occurrence of the cellular event is associated with a decrease in the value of the second signal.

The method may further comprise determining the rate of occurrence of the cellular event at a time t by:
determining the number of tracked cells (Nₐₚ(t, T_{LAG})) for which the value obtained in (i) (µ_{tc}(t)) satisfies the criterion in (ii), at any of time t and times t in a preceding window of time (T_{LAG}); and
determining the number of tracked cells (N_{track}(t)) for which the value obtained in (i) at time t (µ_{tc}(t)) does not satisfy the criterion in (ii), optionally comprising determining N_{track}(t) for each time in the time window t ∈ [t - T_{LAG}, t] and computing a summarized metric (N_{avg}(t, T_{LAG})) of the values thus obtained (such as e.g. the average or median of the values thus obtained); and
comparing the values Nₐₚ(t, T_{LAG}) and N_{track}(t) or N_{avg}(t, T_{LAG}) to obtain a rate of occurrence of the cellular event (O(t, T_{LAG})).

Preferably, N_{track}(t) excludes any tracked cell for which the value obtained in (i) (µ_{tc}(t)) satisfies the criterion in (ii) at any time preceding time t. This advantageously ensures that tracked cells where the event has occurred are not counted even if the signal fluctuates over a few frames following the event.

The use of N_{avg}(t, T_{LAG}) may advantageously result in a more reliable estimate of the number of tracked cells in which the event has not yet occurred, compared to e.g. the instantaneous value at the start of the T_{LAG} window.

O(t, T_{LAG}) may be calculated as

$$O \left(t , {T}_{L A G}\right) = \frac{{N}_{a p} \left(t , {T}_{L A G}\right)}{{N}_{a v g} \left(t , {T}_{L A G}\right)} ⋅ 100 \% \text{.}$$

T_{LAG} may interchangeably be expressed as a unit of time (e.g. minutes, hours) or as a number of frames, as one can be converted into the other by knowing the time interval between consecutive images.

The window of time T_{LAG} may be chosen as 0. In such cases, Nₐₚ(t, T_{LAG}) = Nₐₚ(t). In such cases, the rate of occurrence of the cellular event is calculated on an instantaneous basis (i.e. frame by frame, but taking any previous frame into account in other way than by requiring cells to be tracked before being taken into account in the calculation).

Alternatively, the window of time T_{LAG} may be chosen as > 0. In such cases, the rate of occurrence of the cellular event is calculated taking into account the value of the number of tracked cells for which the value obtained in (i) (µ_{tc}(t)) indicates that the cellular event has occurred at or prior to the beginning of the window of time T_{LAG}. As such, the use of a T_{LAG} reduces the risk of cellular events being erroneously called due to spurious variation. In other words, the parameter T_{LAG} has a dampening effect on the quantification of occurrence of the cellular event. As such, the value of T_{LAG} may be chosen depending on the amount of dampening that is desired, for example depending on whether fast dynamics or slow dynamics are studied (where in the former case smaller values of T_{LAG} are preferred compared to the later). For example, a value of T_{LAG} of as few as 2 frames (or e.g. 1 frame, 3 frames, 4 frames, or the amount of frames that are equivalent to 1 hour, 2 hours, 3 hours or 4 hours) can be chosen when analyzing short term dynamics, and a value of up to 10 frames (or e.g. 7 frames, 8 frames, 9 frames, 11 frames, 12 frames, 13 frames, 14 frames, 15 frames or the amount of frames that are equivalent to 7, 8, 9, 10, 11, 12, 13, 14 or 15 hours hours) may be chosen when analyzing long term dynamics.

The method may further comprise computing the overall survival at time t by:
(a) determining the number of tracked cells (N_{track}(t)) for which the value obtained in (i) at time t (µ_{tc}(t)) does not satisfy the criterion in (ii), optionally wherein N_{track}(t) excludes any tracked cell for which the value obtained in (i) (µ_{tc}(t)) satisfies the criterion in (ii) at any time preceding time t;
(b) determining the total number of tracked cells at a reference time; and
(c) comparing the values obtained in the determining steps to obtain an overall survival at time t.

The reference time is preferably the first time point t₁. Alternatively, the reference time may be the current time point t.

Step (a) may comprise determining the number of tracked cells (N_{track}(t)) for which the value obtained in (i) at time t (µ_{tc}(t)) does not satisfy the criterion in (ii) as the average of N_{track}(t) over a window of time surrounding t, such as e.g. the 3 time points t₋₁, t, t₊₁ (i.e. over window t_{±1} = [t₋₁ -t₊₁]). This value may be referred to as N_{avg2}(t, t_{±1}).

Step (b) may comprise determining the total number of tracked cells at a reference time as the average of N_{track}(t) at time t and the difference between the start and end of a window of time surrounding t. This value may be referred to as N_{avg2}(t, t₁ - t₃) where t₁ and t₃ are the start and end of the window of time, respectively.

Step (c) may comprise computing the overall survival as

$$O S \left(t , {t}_{\pm 1}\right) = \frac{{N}_{a v g 2} \left(t , {t}_{\pm 1}\right)}{{N}_{a v g 2} \left(t , {t}_{1} - {t}_{3}\right)} ⋅ 100 \%$$

. The overall survival may quantify the percentage of cells in which the event has not yet occurred.

The method may further comprise generating an artificial set of images (MD(x,y,t)) of the cell culture at the plurality of consecutive time points (t = 1, ..., T) by, for each occurrence of the cellular event identified in step (iii), including an event region associated with the position

$$\left({x}_{t c} \left({T}_{t c}^{d e a t h}\right) , {y}_{t c} \left({T}_{t c}^{d e a t h}\right)\right)$$

on the image

$$M D \left(x , y , {T}_{t c}^{d e a t h}\right) ,$$

wherein the event regions have a different pixel intensity from the rest of the images.

The event region may be centred at the position

$$\left({x}_{t c} \left({T}_{t c}^{d e a t h}\right) , {y}_{t c} \left({T}_{t c}^{d e a t h}\right)\right)$$

on the image

$$M D \left(x , y , {T}_{t c}^{d e a t h}\right) .$$

The images may be binary, in which case the pixels in the event regions may have a first intensity and all other pixels may have a second intensity. The images may not be binary, in which case a “different pixel intensity” may refer a different summarized pixel intensity, such as e.g. median, average, etc. For example, the event regions may have a pixel intensity ≠ 0 (such as e.g. 1) and all other regions may have a pixel intensity = 0.

The event regions may be circular regions. The shape of the regions may correspond to the shape of the cell as identified by an image analysis algorithm. The region may correspond to the foreground region used in quantifying the second signal in step (i).

Generating artificial set of images (MD(x,y,t)) of the cell culture may further comprise, for each event region in the artificial set of images (MD(x,y,t)), including an event wake region in a set of consecutive images following the image

$$\left(M D \left(x , y , {T}_{t c}^{d e a t h}\right)\right)$$

in which the event region is located, wherein an event wake region in image

$$M D \left(x , y , t ∈ \left\{{T}_{t c}^{d e a t h} + 1 , … , T\right\}\right)$$

is obtained using the event region in the preceding image

$$M D \left(x , y , t ∈ \left\{{T}_{t c}^{d e a t h} , … , T - 1\right\}\right) .$$

An event wake region in image

$$M D \left(x , y , t ∈ \left\{{T}_{t c}^{d e a t h} + 1 , … , T\right\}\right)$$

may be obtained using the event region in the preceding image MD(x,y,t ∈

$$\left(\left\{{T}_{t c}^{d e a t h} , … , T - 1\right\}\right)$$

by applying an erosion operator to each image MD(x, y, t) where (x,y,t)∈{1,.., D₁}×{1,.. D₂}×{2,.. T}.

The event wake region may be defined as a region centred on the same coordinates as the corresponding event wake region in the previous image. Alternatively, the event wake region may be defined as a region centred on the coordinates of the tracked cell at the respective time (i.e. the event wake region at time

$$t ∈ \left\{{T}_{t c}^{d e a t h} + 1 , … , T\right\}$$

may be centred on the position of the tracked cell at the respective times

$$t ∈ \left\{{T}_{t c}^{d e a t h} + 1 , … , T\right\} .$$

The event wake region may be defined as a region with a radius that is linearly dependent on the radius of the event wake region in the previous image and/or the radius of the event region.

The event wake region in the image at time t may be defined as a region centred on the same coordinates as the event region (i.e. in the image at time

$$\left({T}_{t c}^{d e a t h}\right)$$

but with a radius

$${r}_{t c} \left(t\right) = max \left(0 , {r}_{t c} \left({T}_{t c}^{d e a t h}\right) - r ⋅ \left(t - {T}_{t c}^{d e a t h}\right)\right)$$

where r is a predetermined value.

Event wake regions may be defined by generating a further artificial video (M(x,y,t)) as:

$$M \left(x , y , t\right) = {Ψ}_{E}^{B} \left(M \left(x , y , t - 1\right)\right) + M D \left(x , y , t\right)$$

where (x,y,t) ∈ {1,.., D₁}×{1,..D₂}×{2,.. T}, M(x,y, 1) = MD(x,y, 1) and operator

$${Ψ}_{E}^{B}$$

is an erosion operator provided by the formula:

$${Ψ}_{E}^{B} \left(\left(M \left(x , y , t\right)\right)\right) ≜ {min}_{\left({x}^{′} , {y}^{′}\right) ∈ B} \left\{M \left(x + {x}^{′} , y + {y}^{′} , t\right)\right\}$$

where B is a predetermined structure element.

The predetermined structure element may be a circular structure element with a radius r, i.e.

$${B}_{r} ≜ \left\{\left(x , y\right) \vert {x}^{2} + {y}^{2} \leq r\right\} .$$

Other shapes of structure elements may be used such as e.g. square elements, cross elements, etc. Isotropic elements may be preferred as they maintain the symmetry of the objects, particularly where the object has some symmetry.

The radius r may be chosen depending on the expected dynamics of the cellular event. For example, cellular events that are expected to have long term and/or slow effects on surrounding cells may be associated with larger values of r than cellular events that are expected to have short term and/or fast effects on surrounding cells.

The radius r is preferably chosen such that it is expected to be smaller than the

$${r}_{t c} \left({T}_{t c}^{d e a t h}\right) .$$

For example, the radius r may be chosen as a fraction of the average

$${r}_{t c} \left({T}_{t c}^{d e a t h}\right) ,$$

such as e.g. ½ or ⅓ of the average

$${r}_{t c} \left({T}_{t c}^{d e a t h}\right) .$$

Advantageously, in such embodiments, the event regions are expected to have an event region wake that extends on average on two consecutive frames (if r is chosen as ½ of the average

$$\left({r}_{t c} \left({T}_{t c}^{d e a t h}\right)\right)$$

or three consecutive frames (if r is chosen as ⅓ of the average

$$\left({r}_{t c} \left({T}_{t c}^{d e a t h}\right)\right) .$$

The method may further comprise generating one or more cumulative maps (MC(x,y,t, T̃)) that each aggregate the information in consecutive frames of the artificial set of images in a sliding window of size T̃ thereby generating one or more event regions corresponding to areas where an event or event wake was present at any point in time window T̃. Each MC(x,y,t, T̃) may be defined by

$$M C \left(x , y , t , \tilde{T}\right) = \sqrt{{\sum }_{{t}^{′} = t}^{t + \tilde{T}} {\left(M \left(x , y , {t}^{′}\right)\right)}^{2}} , \qquad \text{(9)}$$

with (x,y,t) E {1,..,D₁}×{1,..D₂}×{1,..T - T̃}.

Advantageously, the cumulative map combines in a single signal both the spatial and temporal influence of the cellular events. Indeed, each image in the cumulative map shows the location of cellular events and their wake.

The size of the sliding window T̃ may be chosen depending on the expected dynamics of the cellular event. For example, cellular events that are expected to have long term and/or slow effects on surrounding cells may be associated with larger values of T̃ than cellular events that are expected to have short term and/or fast effects on surrounding cells.

The method may further comprise computing the length of a chain of event by identifying, for a cellular event with position (x_{tc}(t),y_{tc}(t)) and time

$$t = {T}_{t c}^{d e a t h} ,$$

all connected cellular events as the cellular events that occur within a predetermined distance of the position (x_{tc}(t),y_{tc}(t)) and a predetermined time of the time

$$t = {T}_{t c}^{d e a t h} ,$$

repeating this step for each connected event until no more connected events can be identified, and computing the length of all of the chains of events thus identified. The method may further comprise repeating the process for all cellular events. The size of the window T̃ may be chosen as that which is longer than at least a given proportion (e.g. 50%, 60%, 70%, 80% or 90%) of the chains of events thus identified. The predetermined distance may be chosen as a multiple of the expected radius of cells or event regions, such as e.g. 10 times the expected radius of the cells or event regions. The predetermined time may be chosen as equal to T_{LAG}.

The method may further comprise computing for each cumulative map MC(x,y,t,T̃) (or portion thereof), a potential of event induction that takes into account the intensity of each integrated event region in the cumulative map and the relative distances between integrated event regions in the cumulative map (or portion thereof), optionally wherein a potential of event induction is calculated at least in part by:
identifying all non-connected integrated event regions in the cumulative map (or portion thereof);
computing a summarized value of the signal in each non-connected integrated event region;
computing a distance between all pairs of non-connected integrated event regions; and
computing a summarized value for each pair of non-connected integrated event regions, wherein the summarized value for each pair of non-connected event region is proportional to the summarized values of the signal in both of the non-connected integrated event regions in the pair, and inversely proportional to the distance between the pair of non-connected event integrated regions.

The potential of event induction advantageously represents a single parameter per cumulative map or portion thereof (i.e. per time point), capturing the spatio-temporal influence of the cellular events. In particular, the value of the potential of event induction may advantageously be higher when events occur in spatial and temporal clusters (indicating a spatial influence on the occurrence of the events) than when the events occur in a spatially random manner. The value of the potential of event induction may also be higher when events occur according to a temporal pattern that supports the presence of an influence of the occurrence of events on the occurrence of future events. Therefore, by looking at the behavior of a single parameter, it becomes possible to distinguish between cell cultures in which the event occurs in various cells independently, and cell cultures in which the even occurring in some cells changes the likelihood of the event occurring in other cells.

Computing the potential of event induction may further comprise computing a value that combines all summarized values for all pairs of non-connected event regions.

Computing a potential of event induction for each cumulative map MC(x,y,t,T̃) or portion thereof may comprise defining a plurality of portions of a cumulative map and computing the potential of event induction for each portion.

The distance between a pair of non-connected event regions may be the Euclidian distance between the pair of event regions (which may be defined as e.g. the distance between the centres or centres of mass of the regions), optionally normalized by the maximum observed distance in the image. Other distance may be used such as any distance metric selected from: the Quasi Euclidean distance, the ‘minkowski’ distance, the ‘chebychev’ distance, or the Manhattan distance. The potential of event induction may be obtained using the equation below:

$$\begin{matrix}{P}_{d e a t h} \left(t , \tilde{T}\right) ≜ \\ \frac{1}{2 \left|S \left(t\right)\right|} {\sum }_{i = 1}^{\left|S \left(t\right)\right|} {\sum }_{j = i + 1}^{\left|S \left(t\right)\right|} \frac{{\text{mean}}_{\left(x , y\right) ∈ {s}_{i} \left(t\right)} M C \left(x , y , t , \tilde{T}\right) + {\text{mean}}_{\left(x , y\right) ∈ {s}_{j} \left(t\right)} M C \left(x , y , t , \tilde{T}\right)}{\overline{d} \left({s}_{i} \left(t\right) , {s}_{j} \left(t\right)\right)} , \\ i \neq j\end{matrix}$$

where S(t) is the set of non-connected event regions in the image, which may be denoted as

$$S \left(t\right) ≜ \left\{{S}_{i} \left(t\right) \left|{s}_{i} \left(t\right) ∩ {s}_{j} \left(t\right) = ∅ , i \neq j\right)\right\} ,$$

and d̅(sᵢ(t),sⱼ(t)) denotes any distance operator between non-connected regions sᵢ(t) and sⱼ(t), or an equivalent thereof. For example, as the skilled person understands, the factor “½” may be omitted as it applies to all values of P_{death}(t,T̃). Similarly, P_{death}(t,T̃) may also be obtained using:

$$\begin{matrix}{P}_{d e a t h} \left(t , \tilde{T}\right) ≜ \\ \frac{1}{\left|S \left(t\right)\right|} {\sum }_{i = 1}^{\left|S \left(t\right)\right|} {\sum }_{j = i + 1}^{\left|S \left(t\right)\right|} \frac{{\text{mean}}_{\left(x , y\right) ∈ {s}_{i} \left(t\right)} M C \left(x , y , t , \tilde{T}\right) + {\text{mean}}_{\left(x , y\right) ∈ {s}_{j} \left(t\right)} M C \left(x , y , t , \tilde{T}\right)}{2 ∗ \overline{d} \left({s}_{i} \left(t\right) , {s}_{j} \left(t\right)\right)} , \\ i \neq j\end{matrix}$$

or

$${P}_{d e a t h} \left(t , \tilde{T}\right) = \frac{1}{\left|S \left(t\right)\right|} {\sum }_{i = 1}^{\left|S \left(t\right)\right|} {\sum }_{j = i + 1}^{\left|S \left(t\right)\right|} \frac{m e a n \left({\text{mean}}_{\left(x , y\right) ∈ {s}_{i} \left(t\right)} M C \left(x , y , t , \tilde{T}\right) , {\text{mean}}_{\left(x , y\right) ∈ {s}_{j} \left(t\right)} M C \left(x , y , t , \tilde{T}\right)\right)}{\overline{d} \left({s}_{i} \left(t\right) , {s}_{j} \left(t\right)\right)} , i \neq j .$$

Connected event regions may be defined using the 8-connectivity criterion. Conversely, event regions may be considered non-connected if none of the pixels in one region share any vertex or edge with a pixel in another region. Other criteria may be used to define non-connected regions, such as e.g. the 4-connected or 6-connected criteria.

The cell culture may be a 3D culture. 3D cultures are particularly advantageous as they may better recapitulate physiologically relevant conditions such as e.g. the three-dimensional architecture of a tissue, biophysical and biochemical property of extracellular matrix (ECM), and cell-cell interactions. Further, the integration of spatiotemporal information in relation to the occurrence of cellular events as described herein may be particularly valuable in conditions where such spatiotemporal effects are expected to develop and to more accurately recapitulate a physiologically relevant situation (compared to 2D cultures).

In embodiments, the cell culture is a tumour-on-chip or organ-on-chip culture.

The cell culture may comprise multiple populations of cells. The detection of occurrence of a cellular event may be performed for one (e.g. a single one) or more (e.g. multiple or all) of the multiple populations of cells.

The use of multiple populations of cells may be advantageous as it may enable to study the properties of cells in a more physiologically relevant microenvironment, as well as to study the effect of the microenvironment (including the cellular composition of the microenvironment) on the occurrence of cellular events, and the combined effect interaction between experimental conditions (such as e.g. the presence of drugs) and the microenvironments on the occurrence of cellular events.

For example, the step of using an image analysis algorithm to determine the position of cells in at least a first population of cells ((x_{tc}(t),y_{tc}(t)), from the first signal, in each of the images (V(x,y,t)) may be performed such that only the first population of cells is taken into account. This may be performed by choosing the image analysis algorithm and/or its parameters such that visual features associated with the first population of cells are detected. For example, the image analysis algorithm may be configured to detect cells of a particular size and/or morphology. Instead or in addition to this, the first signal may be associated with the first population of cells by using images of cells that have been labelled with a label that is specific to the first population of cells. Instead or in addition to this, the first signal may be associated with the first population of cells by labelling the first population of cells and either not labelling the other population(s) of cells or labelling any other labelled population of cell with a label that is not associated with the first signal (e.g. a label that has a different fluorophore).

In embodiments, the cells have been labelled with a first label that is associated with cells or cell structures and that is associated with the first signal. The cells may have been labelled with a second label that is an event-triggered label and that is associated with the second signal. The first and/or the second label may be fluorescent labels. The cellular event may be apoptosis. In some such embodiments, the second label is a label that emits a signal upon activation of Caspase-3/7.

In embodiments, the method further comprises providing a cell culture.

In a second aspect, the present invention provides a method for analysing the spatiotemporal behaviour of the occurrence of a cellular event in a cell culture, the method comprising:
obtaining image data comprising a set of images (V(x,y,t)) of the cell culture at a plurality of consecutive time points (t= 1,...,T), wherein the image data comprises a first signal associated with the presence of cells and a second signal associated with the occurrence of the cellular event; and
performing the method of the first aspect of the invention using the image data thus obtained.

According to a third aspect, there is provided a computer-implemented method for analysing the spatiotemporal behaviour of the occurrence of a cellular event in a cell culture, the method comprising:
obtaining the timing
$$\left({T}_{t c}^{d e a t h}\right)$$
and position
$$\left({x}_{t c} \left({T}_{t c}^{d e a t h}\right) , {y}_{t c} \left({T}_{t c}^{d e a t h}\right)\right)$$
of occurrence of a cellular event in one or more cells, from image data comprising a set of images (V(x,y,t)) of a cell culture at a plurality of consecutive time points (t = 1,...,T) ;
generating an artificial set of images (MD(x,y,t)) of the cell culture at the plurality of consecutive time points (t= 1,..,T), wherein the images comprise:
an event region associated with the position
$$\left({x}_{t c} \left({T}_{t c}^{d e a t h}\right) , {y}_{t c} \left({T}_{t c}^{d e a t h}\right)\right)$$
on the image
$$M D \left(x , y , {T}_{t c}^{d e a t h}\right)$$
for each occurrence of the cellular event, and
an event wake region in a set of consecutive images following the image
$$\left(M D \left(x , y , {T}_{t c}^{d e a t h}\right)\right)$$
in which each event region is located, wherein an event wake region in image
$$M D \left(x , y , t ∈ \left\{{T}_{t c}^{d e a t h} + 1 , … , T\right\}\right)$$
is obtained using the event region in the preceding image
$$M D \left(x , y , t ∈ \left\{{T}_{t c}^{d e a t h} , … , T - 1\right\}\right) ; \text{and}$$
generating one or more cumulative maps (MC(x,y,t,T̃)) that each aggregate the information in consecutive frames of the artificial set of images in a sliding window of size T̃ thereby generating an integrated event region corresponding to each area where an event or event wake was present at any point in time window T̃.

The method according to the present aspect may have any of the features of any embodiment of the preceding aspects.

Comparing the results of the analysis in the presence and absence of the experimental condition may comprise comparing the rate of occurrence of the event in the presence and absence of the experimental condition. Comparing the results of the analysis in the presence and absence of the experimental condition may comprise comparing the potential of event induction at one or more time points.

According to a fourth aspect, there is provided a method of analysing the effect of an experimental condition on the occurrence of a cellular event in a cell culture, the method comprising:
obtaining image data comprising a set of images (V(x,y,t)) of the cell culture in the presence of the experimental condition at a plurality of consecutive time points (t = 1,...,T), wherein the image data comprises a first signal associated with the presence of cells and a second signal associated with the occurrence of the cellular event;
obtaining image data comprising a set of images (V(x,y,t)) of the cell culture in the absence of the experimental condition at a plurality of consecutive time points (t = 1,...,T), wherein the image data comprises a first signal associated with the presence of cells and a second signal associated with the occurrence of the cellular event;
analysing the image data using the method of any of the embodiments of the preceding aspects; and
comparing the results of the analysis in the presence and absence of the experimental condition.

The experimental condition may comprise the presence of one or more test compounds.

The experimental condition may comprise the presence of one or more further populations of cells, such as e.g. immune cells (e.g. T cells such as CTLs).

According to a fifth aspect, there is provided a method of determining whether a tumour is likely to respond to a treatment, the method comprising: analysing the effect of an experimental condition on the occurrence of a cellular event in a cell culture according to the fourth aspect, where the experimental condition comprises exposure to the treatment, the cellular event is cell death or apoptosis, and the first population of cells comprises cells derived from the tumour. For example, the first population of cells may comprise organoids derived from a primary tumour tissue.

For example, an increase in the rate of occurrence of the event in the presence of the treatment compared to in the absence of the treatment may indicate that the tumour is likely to respond to the treatment. As another example, if the potential of event induction increases over time in the presence of the treatment but not (or to a lesser extent) in the absence of the treatment, this may indicate that the tumour is likely to respond to the treatment.

The treatment may comprise one or more therapeutic molecules (such as e.g. small or complex molecules, e.g. chemotherapy, hormone therapy). The treatment may comprise cytotoxic cells (such as e.g. CTLs, immunotherapy). The treatment may comprise a combination of therapeutic molecules and cytotoxic cells. The treatment may comprise radiotherapy. The experimental condition may comprise the presence of one or more additional populations of cells, such as e.g. stromal cells.

It is specifically contemplated that any computer-implemented method step may take place at a location remote from the cell culture location and/or remote from the imaging location. Further, any of the computer-implemented method steps may take place at different locations (e.g. the computer-implemented method steps may be performed by means of a networked computer, such as by means of a “cloud” provider). Nevertheless, the entire method may in some cases be performed at single location.

In a fifth aspect, the present invention provides a system, comprising:
at least one processor; and
at least one non-transitory computer readable medium containing instructions that, when executed by the at least one processor, cause the at least one processor to perform operations comprising the steps of any of the embodiments of the preceding aspects.

In some embodiments, the system is for use in the method of the first, second, third or fourth aspect of the invention.

In a sixth aspect, the present invention provides a non-transitory computer readable medium, comprising instructions that, when executed by at least one processor, cause the at least one processor to perform operations comprising the steps of any of the embodiments of the first, second, third or fourth aspects.

In some embodiments, the medium is for use in the method of the first, second, third or fourth aspect of the invention.

According to a further aspect, the present invention provides a computer software product for analysing cell culture image data, comprising instructions that, when executed by at least one processor, cause the at least one processor to perform operations comprising the steps of any of the embodiments of the methods described herein.

Embodiments of the present invention will now be described by way of examples and not limited thereby, with reference to the accompanying figures. However, various further aspects and embodiments of the present invention will be apparent to those skilled in the art in view of the present disclosure.

The present invention includes the combination of the aspects and preferred features described except where such a combination is clearly impermissible or is stated to be expressly avoided. These and further aspects and embodiments of the invention are described in further detail below and with reference to the accompanying examples and figures.

### BRIEF DESCRIPTION OF THE FIGURES

FIG. 1 shows a schematic description of a method as described herein. From multi-channel videos of ToC co-cultures, the tracked (cancer) cells (pre-stained in red) are localized and tracked in the red channel. The dying tracked cells (becoming green because of the green caspase reporter) are identified in the green channel, after signal normalization and thresholding. The method monitors tracked cell deaths both in time and in space. The death signal is modeled to vanish during T time frames. Then, the spatio-temporal features of all death signals are integrated in a unique map, from which a parameter, named potential of death induction (P_{death}), is computed over time.

FIG. 2 shows a simulated example for the calculation of the Potential of death induction (P_{death}). Three simulated deaths occur at 2 h, 9 h, and 11 h (first video sequence, top panel). The death signals are modeled by the construction of a signal wake (second video sequence, second panel from the top), the duration of which depends on the dimension of the original death region (first video sequence, top panel). Then, a cumulative map MC(x,y,t,T̃) is constructed by combining both spatial and temporal death influence (third video sequence, third panel from the top) using T̃ = 6. Finally, P_{death} is computed over time for the entire image area (bottom graph). Until t = 8 h, there is only one death, so there is no induction phenomenon. An additional death occurs at t = 9 h thus producing an induction phenomenon and an increase in potential. A third death occurs at t = 11 h thus producing a further increase in the potential value. Potential is also influenced by the absolute value of the map MC and by the distances of the different zones of death. From t = 12 h there is no more memory of the first death, hence only the last two death zones remain whose distance is larger than that of the two death zones involved in t = 9 hr and 11 hr, thus causing a decrease in potential.

FIG. 3 shows simulations illustrating the dependency of the Potential of death induction (P_{death}) on temporal and spatial features. A. Experimental data showing the spatial localization of death events at different time points (top panel), and the corresponding P_{death} measurements (bottom panel) on a video of MDA-MB-231 cells treated with 1 µM doxorubicin (same video as reported in FIG. 8A). B. Simulation of a video with the same death events as in A, but with a spatially random distribution, maintaining approximatively the relative object distances (i.e. same death numbers, same relative distances, but spatially random). Note that the corresponding P_{death} measurements are increasing much less than in A, indicating that the P_{death} increase does not simply result from the increase of death numbers over time, but it depends also on death positions. C. Simulation of a video with a constant number of death events with a spatially random distribution. Note that the corresponding P_{death} measurements are constant over time. D. Simulation of a video with a constant number of death events with a clustered distribution. Note that the corresponding P_{death} measurements are constant over time, but higher than in C. All plots of P_{death} (FIGS. 3, 8 and 9) show the median value of P_{death} (point value) and the range of values of P_{death} calculated over sub-regions extracted from the same cumulative map for (boxes).

FIG. 4 shows a study of chemotherapy-mediated cytotoxicity in breast-cancer-on-chip cultures. A. Experimental design: breast cancer MDA-MB-231 cells are embedded in a collagen matrix in the central chamber of the chip; cells are live-imaged in transmission channel and fluorescence channels (red and green) every hour for 72 h, without or with doxorubicin (1 µM). B. Representative images of MDA-MB-231 cells after one hour, 24 h and 48 h of culture on-chip, without doxorubicin (uppers panels) or with doxorubicin (lowers panels). Red arrows (no star) indicate living cells, whereas green arrows (highlighted with white stars) point at apoptotic cells. Scale bar, 100 µm. C. Time-course quantifications of the apoptosis rate, calculated in 10 h-time-intervals, showing the comparison between manual counts (red squares) and automatic counts (black rounds, T_{LAG} = 10 h), without (left) or with (right) doxorubicin. Mann-Whitney-Wilcoxon statistical test was used; ns, not significant.

FIG. 5 shows a study of T-cell mediated cytotoxicity in lung-cancer-on-chip cultures. A. Experimental design: the lung cancer IGR-Pub cells are embedded in a collagen matrix in the central chamber of the chip, alone or together with autologous cytotoxic T cells (P62 clone); cells are live-imaged in transmission channel and fluorescence channels (red and green) every hour for 48 hrs. B. Representative images of IGR-Pub cells after one hour, 24 hrs and 48 hrs of culture on-chip, alone (uppers panels) or with autologous T cells (lowers panels). Red arrows (no star) indicate living cells, whereas green arrows (highlighted with white stars) point at apoptotic cells. Blue arrows (highlighted with grey stars) indicate T cells. Scale bar, 100 µm. C. Time-course quantifications of the apoptosis rate, calculated in 10 h-time-intervals, showing the comparison between manual counts (red squares) and automatic counts (black rounds, T_{LAG} = 10 h), without (left) or with (right) T cells. Mann-Whitney-Wilcoxon statistical test was used; ns, not significant.

FIG. 6 shows the real-time dependency of T-cell mediated cytotoxicity on T cell density. IGR-Pub cancer cells were co-cultured on-chip with different ratios of autologous T cells, as indicated (E:T ratios). A. Time-course quantifications of the apoptosis rate, calculated in 4 hours-time-intervals (T_{LAG} = 4 h), for a total duration of 48 hrs. B. Survival curves of cancer cells within the ToC at 1-h time resolution. For each tᵢ the % of surviving cells, calculated with respect to the initial number of living cells, is the average of 3 hours, centred on tᵢ, to smoothen the fluctuations. The graphs show the mean of 3 measurements coming from 3 videos of the same experiment (+/- SEM).

FIG. 7 shows data indicating that cancer-associated fibroblasts promote chemo-resistance in breast-cancer-on-chip. MDA-MB-231 cancer cells were co-cultured on-chip +/- cancer-associated fibroblasts (CAFs) and +/- doxorubicin (1 µM) treatment. Final CAF:cancer ratio was 1:6. The graph shows the time-course quantifications of the apoptosis rate, calculated in 4 hours-time-intervals (T_{LAG} = 4 h), for a total duration of 68 hrs. The data are the means of 3 measurements coming from 3 videos of the same experiment (+/- SEM). The data illustrating the MDA-MB-231 without CAFs conditions come from the same videos analyzed for FIG. 4 but with different time-interval resolution.

FIG. 8 shows data indicating that the Potential of death induction (P_{death}) of cancer cells increases over time upon cytotoxic death, but not upon natural death. A. Representative P_{deαth} analysis on one video of breast cancer MDA-MB-231 cells cultured within ToC without (left, natural death) or with 1 µM doxorubicin (right, cytotoxic death). B. Representative P_{death} analysis on one video of lung cancer IGR-Pub cells cultured within ToC alone (left, natural death) or together with autologous cytotoxic T cells (CTL) (P62 clone) (right, cytotoxic death).

FIG. 9 shows further data indicating that the Potential of death induction (P_{death}) of cancer cells increases over time upon cytotoxic death, but not upon natural death. A. P_{death} analysis on further videos of breast cancer MDA-MB-231 cells cultured within ToC without (top row, natural death) or with 1 µM doxorubicin (bottom row, cytotoxic death). B. P_{death} analysis on further videos of lung cancer IGR-Pub cells cultured within ToC alone (top row, natural death) or together with autologous cytotoxic T cells (P62 clone) (bottom row, cytotoxic death).

FIG. 10 shows data illustrating the rationale for the calculation of a suitable T̃ . T̃ is the time window over which the aggregation of deaths and their wake were computed by means of the definition of cumulative map MC (Eq. (9)). The induction intervals, defined as the duration of the chain of death, were computed for each cell, from 16 videos from 2 experiments, one experiment with lung cancer IGR-Pub cells (A) and one experiment with breast cancer MDA-MB-231 cells (B). The distributions of induction show that the vast majority of induction intervals is below 16 h, meaning that T̃ = 16 h is an optimal choice.

### DETAILED DESCRIPTION OF THE INVENTION

In describing the present invention, the following terms will be employed, and are intended to be defined as indicated below.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

“Computer-implemented method” where used herein is to be taken as meaning a method whose implementation involves the use of a computer, computer network or other programmable apparatus, wherein one or more features of the method are realised wholly or partly by means of a computer program.

A “cell culture” (also referred to herein as “sample”) as used herein may be a system comprising one or more populations of cells growing in or on a substrate. The substrate may comprise a coated or uncoated surface (such as e.g. the surface of a cell culture dish), or a matrix in which cells can be embedded. The cell culture may be a 2D culture (e.g. a 2D dish culture) or a 3D culture (e.g. an organ-on-chip or tumour-on-chip culture, thin 3D gel etc.). The cell culture is preferably a 3D culture. A 3D culture comprises a substrate through which the cells are able to move (preferably slowly) in 3 dimensions and/or through which cells can be located in 3 dimensions (for example by being embedded in a matrix or by being located in multiple compartments separated by at least partially permeable structures such as e.g. membranes). A cell culture that comprises a substrate in the form of a matrix in which cells are embedded is typically (but not obligatory) a 3D culture. The substrate may comprise a microfluidic chip. The microfluidic chip may comprise a plurality of compartments in fluidic communication. The microfluidic chip may be connected to a fluid circulation system which may comprise one or more pump, lines and containers to supply a flow of solution (such as e.g. culture medium, optionally supplemented with one or more test compounds) to one or more compartments of the microfluidic chip. The cell culture preferably comprises isolated cells. Isolated cells, as opposed to cell clusters, organoids, spheroids, etc. may be more efficiently and/or accurately identified and tracked using some of the methods described herein. For example, the use of a circular Hough transform (as further described below) to locate cells on images may be particularly advantageous to detect cells that are expected to appear as individual cells on images. Similarly, the construction of cell tracks using e.g. the Munkres algorithm may be particularly advantageous in combination with isolated cells. The cell culture preferably comprises static or slow-moving cells, such as e.g. cells embedded in a matrix. Slow-moving cells may advantageously be accurately tracked using time-lapse images and/or cell tracking methods as described herein. For example, the construction of cell trackes from time-lapse images, e.g. using the Munkres algorithm, may be more accurately performed where cell movement between time points is expected to be limited.

The populations of cells may each be from a particular cell type such as e.g. a particular type of cancer cell (e.g. a cancer cell line), a particular type of immune cell (e.g. PBMC cells, T cells, etc.), a particular type of connective tissue cell (such as e.g. a fibroblast), etc. The populations of cells may originate from different organisms. The cells in a population may be eukaryotic cells, and in particular mammalian cells such as e.g. human, mouse, rat, rabbit, or hamster cells. Any cell that can be cultured in vitro, such as e.g. any cell line, whether established or derived from primary tissue, can be used within the context of the present disclosure. In particularly advantageous embodiments, the one or more populations of cells comprise at least two different populations of cells. Such embodiments may be referred to as “co-cultures”. The at least two populations of cells may be e.g. a population of tumour cells and a population of non-tumour cells such as e.g. connective tissue cells, immune cells, etc., or multiple populations of cells that co-exist in an organ such as e.g. a population of epithelial cells and a population of endothelial cells. Such embodiments advantageously enable to study the properties of a tumour or organ in a physiologically more realistic set up than e.g. using pure culture of cell lines. For example, such embodiments enable to study the effect of a tumour microenvironment on the properties of a tumour including e.g. drug response, anti-cancer immune response, etc. It is further advantageous for the culture to be a 3D culture, such as e.g. using a culture substrate that comprises a microfluidic chip (in which case the cell culture may be referred to as a “tumour-on-chip” or “organ-on-chip”). Indeed, many properties of interest such as e.g. cell cycle regulation, cellular signalling and drug sensitivity are known to be different if a cell culture is performed in a 3 dimensional set-up, as opposed to a 2 dimensional set up - the former being likely to be closer to the physiological situation. The cells in the cell culture may be stained using one or more labels, such as e.g. labels comprising fluorescent dyes. Further, where multiple populations of cells are used, one or more of the cell populations may be stained (together or individually) prior to mixing the cell populations. Alternatively, the presence and/or properties of cells (such as e.g. cell type, morphology, state (e.g. dead or alive) may be detected without using a label. For example, transmission microscope images may be used to detect the presence and/or properties of cells. Further, a combination of label-free and label-originating signals may be used. For example, a first property (such as e.g. the presence of cells) may be detected using transmission microscope images (i.e. without a label), and a second property (such as e.g. the occurrence of an event such as cell death) may be detected using a label and associated visualisation protocol (such as e.g. a fluorescent label and a fluorescent microscope). Where multiple populations of cells are present, some or all of the populations of cells may be analysed as described herein. Preferably, the population(s) of cells that is/are tracked appear as round or substantially round shapes on cell culture images. Substantially round cells may be more efficiently analysed using some of the methods described herein. For example, the use of a circular Hough transform (as further described below) to locate cells on images may be particularly advantageous to detect cells that are expected to have a substantially circular shape on images.

A “label” as used herein is a compound that can be used to detect biological material in combination with an appropriate visualisation protocol. In particular, labels are compounds that associate with cells, cellular structures (such as membranes, mitochondria, nuclei, etc.) or macromolecules (e.g. specific peptides, proteins, DNA, etc.) present in cellular cultures and are detectable using an appropriate visualisation protocol. For example, the labels may be directly or indirectly (such as e.g. using a secondary label) associated with a fluorophore, chromophore or radioisotope. The label may be a permanent label or an event-triggered label. A permanent label is one that is permanently associated with a detectable signal. For example, a permanent label may be a label that associates with cells or cellular structures (such as e.g. nuclei) in a permanent or semi-permanent manner (such as e.g. while the cell is alive). For example, mKate2 is a nuclear label, and CellTrace™ Yellow is cell label. Both labels non-selectively associate with cells and are compatible with cell proliferation, thereby being usable to detect live cells. Further, different labels may be used to label different populations of cells, such that each differently labelled population can be individually analysed. For example, CellTrace™ exists in 4 colours so up to 5 different cell populations could potentially be analysed separately (4 colours + unstained) by staining the cells with CellTrace™ prior to mixing. An event-triggered label is a label that is only associated with a detectable signal when a particular cellular event occurs. For example, an event-triggered label may comprise a fluorophore that is coupled to an inhibitor, where the event causes the release of the fluorophore, whose signal becomes detectable (e.g. CellEvent Caspase-3/7 Green Detection Reagent). As another example, an event-triggered label may comprise a labelled compound that only associates with cells or cellular structures after an event has occurred. For example, the compound may only be taken up by dead cells (e.g. Sytox Green) For example, a cellular event may be apoptosis, cell death, mitosis, etc. The labels are preferably compatible with the maintenance of live cells in culture, i.e. the labels are preferably non-cytotoxic.

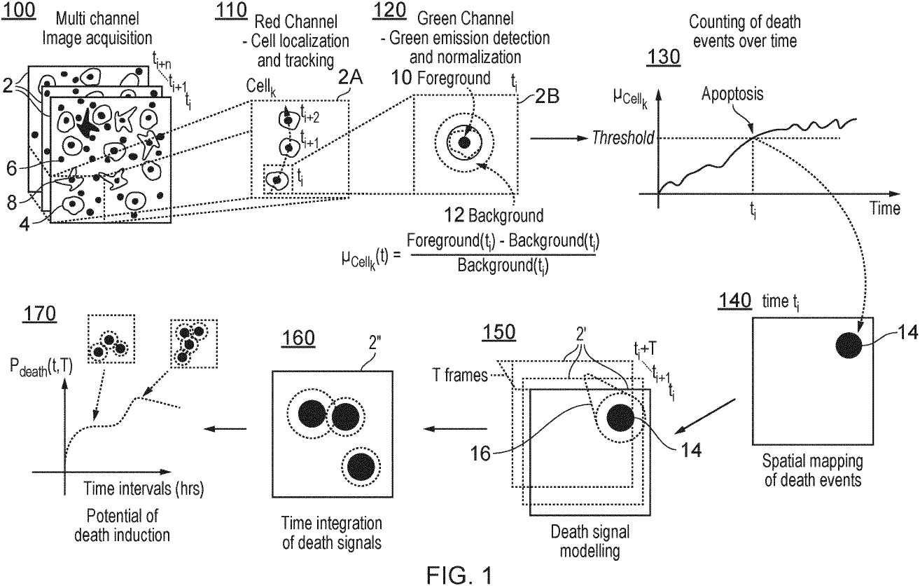

FIG. 1 illustrates a method for analysing cell culture images. At step 100, image data associated with a cell culture is provided to a computing device. The computing device is preferably configured to implement a method for detecting cellular events in cell culture as described herein. The image data comprises a set of n+1 images 2 that show a cell culture at consecutive time points tᵢ to tᵢ₊ₙ. Such a set of images may also be referred to as a video or time-lapse images. In the embodiment shown, the image data images comprise information from at least two channels, such as e.g. a first “colour channel” and a second “colour channel” (associated with different detection wavelengths, although images obtained for the respective channels may in practice be binary (black and white) or grayscale images). The information from the different channels may be treated as separate sets of images, each set comprising n+1 images that show the signal from a respective channel at consecutive time points tᵢ to tᵢ₊ₙ. In other embodiments, the information from the different channels may be provided as separate sets of images.

Providing cell culture image data may optionally comprise obtaining cell culture image data by imaging a cell culture at regular intervals over a time period. The images may be acquired at time intervals of e.g. one or more seconds, minutes or hours. As the skilled person understand, this means that the consecutive time points tᵢ to tᵢ₊ₙ may be separated by one or more seconds, minutes or hours. Advantageous time intervals may depend on a variety of factors including the dynamics of the cellular event to be analysed, the speed of movement of the cells, any photo-toxicity associated with image acquisition, image processing limitations etc. For the purpose of studying apoptotis, especially in a matrix environment, the present inventors have found time intervals of 1 hour to be advantageous. The method may further comprise providing a cell culture, for example by providing one or more populations of cells in or on a substrate. In the embodiment shown on FIG. 1, the cell culture includes 3 populations of cells: a first population of cells 4 (e.g. cancer cells), a second population of cells 6 (e.g. T cells), and a third population of cells 8 (e.g. fibroblasts). The cell culture may additionally include one or more test compounds, such as e.g. a drug. One or more of the cells or cell populations in the cell culture may have been previously stained using one or more labels, and/or may be labelled with one or more labels in the course of the experiment (i.e. in the time course tᵢ to tᵢ₊ₙ). The labels comprise a first label that enables the detection of live cells, in a cell-type specific or non-specific manner. For example, the first label may be a permanent label that associates with one or more cellular components, such as e.g. CellTrace™ Yellow. Where the first label is cell-type specific, the cells may have been previously labelled or may be labelled during the course of the experiment. Where the first label is non-specific, one or more of the cells or cell populations may have been previously labelled (e.g. if it is advantageous for only a subset of the cells to be labelled). Alternatively, substantially all cells may be labelled during or prior to the first image acquisition at tᵢ. The labels comprise a second label that is an event-triggered label. For example, the cellular event may be apoptosis, in which case the second label may be the CellEvent Caspase-3/7 Green Detection Reagent. Using an event-triggered label, cells may be labelled as a triggering event occurs in the cell during the course of the experiment. Imaging the cell culture may be performed using e.g. a microscope (such as e.g. an optical or fluorescence microscope, depending on the nature of the labels used) equipped with image acquisition means. In the embodiment shown, the first label is associated with a signal in a first channel 2A (referred to as “red channel” on FIG. 1), and the second label is associated with a signal in a second channel 2B (referred to as “green channel” on FIG. 1).

The signal in the first channel 2A is used at step 110 to determine the position of cells in at least a first population of cells, at each time point (i.e. in each of the images 2). In the embodiment shown, the signal in the first channel 2A is associated with one of the population of cells, the first population 4. All subsequent steps are applied to those labelled cells. In other words, other (i.e. unlabelled) populations of cells will not be analysed in the following steps in the embodiment shown. The position of each of the labelled cells that has been localised in each of the images 2 is linked into a respective cell track (one track per localised cell). The signal in the second channel is used to identify the timing and position of occurrence of a cellular event in each cell track in which an event (associated with the event-triggered label) has occurred through steps 120-140. At step 120, the signal in the second channel 2B is mapped to a track as determined at step 110. A second signal for the track is quantified by identifying a foreground region 10 and a background region 12 around each cell position in a respective track and performing background subtraction and normalisation. In the embodiment shown, this is performed by subtracting a summarised value for the background region from a summarised value for the foreground region, and normalising the resulting value relative to the summarised value for the background region. In the embodiment shown, the foreground region 10 is a circular region that is centred on the position of the respective cell as identified using the first signal 2A at step 110. In the embodiment shown, the background region 12 is an annular region with the same centre as the foreground region 10, extending outwards from the foreground region up to a predetermined radius.

At step 130, a time point tᵢ at which the value of the second signal for a track crosses a threshold, at which point the event that is associated with the event-triggered second label is deemed to have occurred. In the embodiment shown, the event is cell death - in particular cell death by apoptosis. As such, the event may be referred throughout the subsequent steps as “death”. References to an event as “death” should be interpreted to refer to any type of event that can be analysed in a similar way, unless the context indicates otherwise. The threshold may be identified by combining all values for the second signal for all tracks (as obtained at step 120) and identifying a threshold that separates two populations of values: one in which the event is assumed not to have occurred and one in which the event is assumed to have occurred. This may alternatively be performed by fitting two distributions (e.g. using a Gaussian mixture model) and identifying the threshold that best separates the two distributions (e.g. the threshold that is associated with the lowest probability of classifying a value in the “wrong” population). This may be performed by identifying a value that separates the values in two sets of values that have minimal intra-class variance (which is equivalent to maxima inter-class variance).

At step 140, the timing of occurrence of the event is associated with the position of the cell at the time point at which the event was determined to have occurred. In other words, for each cell track in which the event was determined to have occurred (i.e. each cell track in which the value of the second signal crossed the threshold at step 130), a timing and location of occurrence of the event are determined. A location of occurrence of the event may comprise a position (e.g. a set of coordinates

$$\left({x}_{t c} \left({T}_{t c}^{d e a t h}\right) , {y}_{t c} \left({T}_{t c}^{d e a t h}\right)\right) ,$$

where the coordinates may correspond to the centre of the foreground region of step 120, the centre of mass or a cell region as determined using a cell localization algorithm at step 110, or any other set of coordinates that can be used to summarized the position of a tracked cell) associated with each tracked cell in which the event has been detected, at the time at which the event has been detected. A location of occurrence of the event may instead or in addition comprise a region 14(e.g. a circular region such as e.g. the foreground region of step 120) associated with each tracked cell in which the event has been detected, at the time at which the event has been detected. This is referred to herein as an “event region”. The timing of occurrence of the event enables the determination of the event rate (O(t,T_{LAG})). The event rate is the percentage of tracked cells in which the event has occurred within a predetermined time window T_{LAG}. Using timing of occurrence of the event, it is further possible to determine the percentage of tracked cells in which the event has not occurred, as a function of time. Where the event is apoptosis, this may also be referred to as the overall survival. This may be calculated at any one time relative to the number of tracked cells at the time. This may alternatively be calculated at any one time relative to the initial number of tracked cells. The combined timing and position of occurrence of the event may further be used to investigate the effect of occurrence of the event in the tracked cells on occurrence of the event in other tracked cells. This may be performed by obtaining a spatiotemporal map of the events (MC(x,y,t,T̃)) at steps 150-160, and obtaining a parameter (P_{death}(t,T̃)) that quantifies the spatiotemporal behaviour of the pattern of occurrence of the event at step 170.

At step 150, an artificial set of images 2′ is generated using the location information from step 140. An artificial image is generated for each time point (t = 1,...,T) that has been analysed in the previous step. Each artificial image is associated with a time tᵢ and comprises an event region 14 for each event that has been detected at time point tᵢ. The event regions 14 have a different pixel intensity from the rest of the images. In the embodiment shown, the artificial images 2′ are binary: the event regions 14 have a pixel intensity of 1 and the rest of the images have a pixel intensity of 0. The artificial images 2′ further include an event wake region (schematically illustrated as the cone 16) associated with each event region 14, in each of a set of T images that follows the image in which an event region 14 is present (images at t=t₁₊₁...t_{i+T}). An event wake region 16 is a set of regions of progressively decreasing size, each associated with an image in a set of T images that follows an image in which an event region 14 is present. In other words, the region 16ᵢ₊₂ in the image corresponding to tᵢ₊₂ is smaller than the region 16ᵢ₊₁ in the image corresponding to tᵢ₊₁, which is itself smaller than the region 16ᵢ in the image corresponding to tᵢ. The event wake region in an image can be defined on the basis of the event wake region in the preceding image (or original event region, if the event wake region is the first region in a set of wake regions, i.e. the region at tᵢ₊₁), and the position of the cell in the current image (e.g. as determined at step 110). For example, a subsequent event wake region can be calculated by applying an erosion operator to the region in the current image.

At step 160, a spatiotemporal map 2″ (also referred to herein as “cumulative map” or “time integrated map”) of the events captured in the artificial set of images 2′ is obtained by integrating the information in the artificial set of images 2′ over a window of time T̃. For example, the spatiotemporal map 2″ at time t may sum the signal (or the squared signal) in each of the artificial images 2′ between t and t+T̃ at each pixel location i.e. on a pixel location by pixel location basis. The square root of the resulting value for a pixel location may represent the value of that pixel in the spatiotemporal map 2″ associated with time t. This may be repeated using a sliding window of time T̃, up until t=t₁₊ₙ-T̃. On FIG. 1, the window of time T̃ is indicated as “T”, and only T frames are shown. As such, a single spatiotemporal map 2″ is obtained. If the artificial set of images 2″ contained T+1 frames, then it would have been possible to obtain two spatiotemporal maps 2″: one integrating the signal between tᵢ and t_{i+T}, and one integrating the signal between tᵢ₊ᵢ and tᵢ₊₁+T. A spatiotemporal map 2″ combines the information about all events that have occurred between t and t+T or occurred before t and are associated with an event wake region in any of the times between t and t+T. This results in one or more integrated event regions 18. The spatiotemporal maps 2″ are not binary even if the artificial images 2″ were binary. This is because the combination of the event region and its decreasing wake leads to a region that has the outer dimensions of the event region or the largest event wake region in a set included in the spatiotemporal map, with a signal that increases inwards from the outer dimensions (as at every subsequent time step the region that does contain signal from the event region wake decreases).

At step 170, a parameter (P_{death}(t,T)) that quantifies the spatiotemporal behaviour of the pattern of occurrence of the event is obtained using the spatiotemporal map 2″. The parameter is referred to as “P_{death}” on FIG. 1, as the event illustrated on FIG. 1 is cell death. However, references to P_{death} should be interpreted to refer to the potential of event induction for any event that can be monitored as described above. A value of P_{death} can be calculated for each spatiotemporal map 2″ by: identifying the integrated event regions 18 in the spatiotemporal map 2″ and computing, for each pair of identified integrated event regions 18, a parameter that balances the strength of the signal in the integrated event regions 18 and the distance between the integrated event regions 18 in the pair. In practice, the integrated event regions 18 may be identified by assuming that every non-connected region in a spatiotemporal map represents a single integrated event region 18. A non-connected region may be defined as a continuous region where signal is present (e.g. a set of pixels of non-zero values that is surrounded by pixels of zero value, where connected pixels can be defined using the 8-connectivity criterion). Using 8-connectivity criterion, a pixel is considered to be connected to another pixel if they share any vertex or corner. Without wishing to be bound by theory, it is believed that this is reasonable to assume that the integrated event regions 18 correspond to the set of non-connected regions when the spatiotemporal maps 2″ are expected to be sparse (i.e. the integrated event regions 18 are sparsely distributed over the spatiotemporal maps 2″). Further, the use of non-connected regions may advantageously mean that the parameter captures effects of one event onto the occurrence of another (rather than e.g. the occurrence of two events due to a common cause triggering both events. The use of non-connected regions may also mean that the parameter advantageously captures effects at a particular spatial scale of interest (depending also on the size of the event region and event wake region used). The strength of the signal in a pair of integrated event regions 18 may be calculated as the sum of the mean signal over each of the respective integrated event regions 18. The distance between two integrated event regions 18 may be calculated as the Euclidian distance between the centres (or centres of mass) of the two integrated event regions 18. Further, this can be calculated for every possible pair of integrated event regions 18 that have been identified, and the resulting values can be summed and normalised relative to the number of pairs that have been considered (e.g. by dividing by twice the number of pairs that have been considered, where the strength of signal for a pair is the sum of the mean signal in each region of the pair).

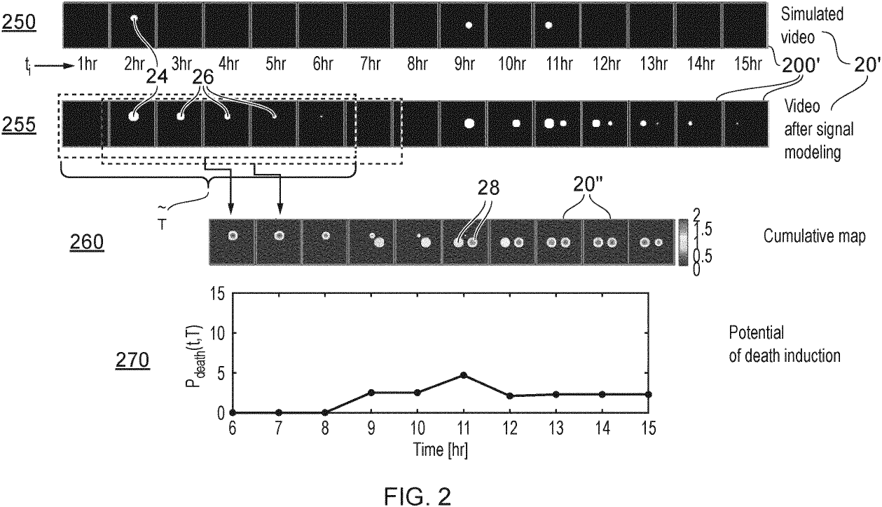

FIG. 2 illustrates a method of analysing the spatiotemporal pattern of occurrence of a cellular event in a cell culture, as described herein. This is performed by obtaining a spatiotemporal map of occurrence of a type of events (e.g. cell death, apoptosis, etc.) and optionally quantifying the spatiotemporal behaviour of the pattern of occurrence of the events. The method can optionally be performed as part of a method as explained in relation to FIG. 1. In other words, steps 100 to 140 on FIG. 1 are optional and may not be performed in some embodiments of the methods described herein.

The method comprises generating a simulated video 20′ comprising an artificial set of images 200′ through steps 250-255, using information about the location and timing of occurrence of a type of cellular events extracted from image data of a cell culture. The information may have been extracted using a method as illustrated in relation to FIG. 1, steps 100-140. Alternatively, the information may have been extracted using any other method suitable for detecting the location and position of occurrence of a cellular event in cells in a cell culture. Each artificial image 200′ is associated with a time tᵢ and an event region 24 is included in each image in which the occurrence of the event has been detected at the corresponding time point tᵢ. The event regions 24 have the characteristics described above in relation to FIG. 1. An event wake region 26 is then included at step 255 in each of a set of T images 200′ that follows the image in which an event region 24 has been (images at t=t₁₊₁...t_{i+T}). An event wake region 26 may be defined as explained above in relation to FIG. 1.

At step 260, one or more cumulative maps 20″ (also referred to herein as “spatiotemporal map”) of the events captured in the simulated video 20′ is obtained by integrating the information in the artificial set of images 200′ over a sliding window of time, as explained above in relation to FIG. 1. This results in one or more integrated event regions 28.

At step 270, a parameter (P_{death}(t,T)) that quantifies the spatiotemporal behaviour of the pattern of occurrence of the event is obtained for each cumulative map 20″. The parameter is referred to as “P_{death}” on FIG. 2. However, references to P_{death} should be interpreted to refer to the potential of event induction for any event that can be monitored as described herein. A value of P_{death} can be calculated for each cumulative map 20″ by: identifying the integrated event regions 28 in the spatiotemporal map 20″ and computing, for each pair of identified integrated event regions 28, a parameter that balances the strength of the signal in the integrated event regions 28 and the distance between the integrated event regions 28 in the pair, as explained above. As can be seen on FIG. 2, the value of P_{death} is 0 for a cumulative map 20″ that contains a single integrated event region 28. The value of P_{death} increases when a second integrated even region 28 appears, and again when a third integrated event region appears. The value of P_{death} then decreases as no further integrated event regions 28 appear, and the signal in the integrated event regions 28 decreases. Further, the value of P_{death} is dependent on the relative distances between the integrated event regions 28 that coexist on a cumulative map: the closer the integrated event regions, the higher the value of P_{death}. While embodiments using 2D images are illustrated herein, the same principles can be used for 3D images. For example, the process applied for 2D images can be used for each of a series of 2D images acquired on a single depth plane. Alternatively, the methods illustrated herein for 2D images can be extended to 3D images, by using positons in a (x,y,z) system of coordinates (with appropriate modifications of the formulae provided herein) and 3D cell tracking. Further, this may include defining regions as 3D objects rather than 2D objects (e.g. spherical regions may be used instead of circular regions).

The method described in relation to FIGS. 1 and 2 may be used to automatically detect the occurrence of one or more cellular events in a cell culture, and in particular to quantify the spatiotemporal properties of occurrence of the one or more cellular events. For example, the method may be applied to study apoptosis in a cell culture. As a result of the method, it is possible to study the impact of various experimental parameters on apoptosis of cells in the culture in a spatially and temporally resolved manner. This enables in particular the investigation of the effect of occurrence of apoptosis on other cells in the cell culture, and how this effect is modulated by experimental conditions such as the presence or absence of test compounds or the cellular composition and/or organisation of the cell’s microenvironments. The method described in relation to FIGS. 1 and 2 may instead or in addition be used for automated analysis of cell death (other than by apoptosis, or including but not limited to death by apoptosis) in cell cultures. Similarly, the methods described herein may be used for automated analysis of other cellular events such as e.g. cell proliferation, the S phase of the cell cycle (e.g. by detecting the synthesis of DNA), the activation of a relevant enzyme, any biochemical activity that can be monitored by a reporter (such as e.g. FRET-based biosensors for enzymatic activities), etc.

The following is presented by way of example and is not to be construed as a limitation to the scope of the claims.

### EXAMPLES

### Overview of Findings

Because of their capacity to capture the cell death kinetics, image analysis approaches are progressively replacing the historical endpoint cytotoxic assays, such as the luminescent detection of ATP [9] or the ⁵¹Cr-release assay [10]. For example, a recent work combined live/dead cell markers and mathematical modelling to achieve a high-throughput analysis of cell death kinetics (i.e. the number and proportion of dead cells in each frame) with over 1800 bioactive compounds [11]. Similarly, image analysis algorithms to measure cytotoxic or apoptotic index are commercially available from companies selling cell imaging systems (such as IncuCyte-Essen BioScience or NanoLive). A real-time bio-imaging cytotoxic assay has been proposed for 96-well microplate [12]. All these software tools have been conceived to work in 2D settings, with focus on temporal information, ignoring spatial effects and the interaction of time and space features. By contrast, the present work includes spatial information (i.e. analysing where cells die, not only when cells die). The present work is applicable to 2D as well as 3D culture settings, and investigates both spatial and temporal information. Recently, a 96-well microfluidic platform was developed to perform bio-imaging cytotoxic assays in 3D gels [13]. However, automated analysis was limited to the estimation of the number of live and dead cells per area of cells (where the former are distinguished from the latter using a dye that labels dead cells) over time. Since 3D microfluidic devices allow to keep confined the cells and also their released soluble factors, they are appropriate to investigate the consequences of each death event on surrounding cells. For this purpose, the work described in the examples below focused on analysis strategies to extract not only the temporal information, but also the spatial information of cancer death events. For this purpose, the new concept of “Potential of Death induction” was introduced, by calculating the induction that each death region (defined as ‘object’) produces on the surrounding death regions, with respect to their mutual distances and to their temporal relationships. The combination of measures both in time and in space allowed to conduct an original apoptosis analysis that accounts not only for the number of death events and their kinetics, but most significantly for their spatial distribution in the 3D confined environments of ToC cultures.

### Materials and Methods

Cell cultures The MDA-MB-231 cell line, from triple negative breast cancer, was cultured in high-glucose DMEM (GE Healthcare, #SH30081.01) supplemented with 10% fetal bovine serum (Biosera), 1% Penicillin/Streptomycin (Gibco), 1% glutamine (Gibco). The IGR-Pub lung adenocarcinoma cells and the autologous T cells P62 were harvested from the same patient in Institut Gustave Roussy [14]. The IGR-Pub cells were cultured in DMEM F12 (GIBCO) supplemented with 10% fetal bovine serum (Biosera), 1% of Ultroser G (Pall), 1% of Sodium Pyruvate (Gibco) and 1% Penicillin/Streptomycin (GIBCO). P62 T cells were cultured in RPMI-1640 (GE Healthcare) supplemented with 10% human AB serum (Institut Jacques Boy, Reims, France), rIL-2 (20 U/ml, Gibco), 1% of Sodium Pyruvate (Gibco) and 0.1% Penicillin/Streptomycin (Gibco). Primary cancer-associated fibroblasts (CAFs) were isolated and cultured as previously reported [8,22]. All cell lines were periodically tested to exclude mycoplasma contamination using a qPCR-based method (VenorGem Classic, BioValley, #11-1250). The MDA-MB-231 cell line was authenticated by SRT profiling (GenePrint 10 system, Promega, #B9510). Doxorubicin was purchased from Teva pharmaceuticals (200 mg/ml).

Tumor-on-chip preparation The microfluidic devices were purchased from AIM-Biotech (#DAX-1). Cells were seeded in the central chamber of the DAX-1 chips embedded in a matrix composed of type I rat tail collagen (Thermofisher, #A1048301) at the final concentration of 2.3 mg/ml. Cancer cells were seeded in the gel at a final density of 2×10⁶ cells/ml. Autologous T cells were added at final densities of 0.2×10⁶ to 2×10⁶ cells/ml in order to obtain different ratios (from 10:1 to 1:1) between cancer and T cells. Primary CAFs were added at cancer:CAF 6:1 ratio. The microfluidic devices were incubated for 30 min at 37° C. in a humidified chamber to allow the polymerization of the collagen solution; afterwards, 120 µl of culture medium were added in each lateral chamber. MDA-MB-231 cells in chip were cultured in the same medium used for dish 2D culture, whereas the IGR-Pub/P62 cells co-cultures were cultured in T-cell medium, supplemented with rIL-2 (10 U/ml, GIBCO, #PHC0027). After the addition of the medium, the microfluidic devices were kept for 1 hour in the incubator before transfer to the incubating chamber of the microscope for imaging.

Cell staining Cancer cells were labeled with CellTrace™ Yellow (Thermofisher, #C34567) before seeding in the gel, for the detection in the so-called “red channel” of fluorescence. Cells were trypsinized, and then resuspended at 1×10⁶ cells/ml density in PBS with 5 µM CellTrace™ Yellow; after incubation in cell medium for 5 min at 37° C., cells were centrifuged at 300 g for 5 min, resuspended in PBS and added to the rat-tail collagen solution. CellTrace™ Yellow is a fluorescent dye with yellow excitation at 546-nm (e.g. for excitation by either a 532-nm or 561-nm laser) and emission at 579-nm. The dye is cell permeant and cleaved by intracellular esterases to yield a highly fluorescent compound that covalently binds to cellular amines, attaching to various cellular components. CellTrace™ exists in 4 colours so up to 5 different cell populations could potentially be analysed separately (4 colours + unstained) by staining the cells prior to mixing.

CellEvent™ Caspase-3/7 Green Detection Reagent (Thermofisher, #C10423) was added to the medium in the lateral chamber of the chip in order to visualize in the “green channel” the cells undergoing apoptosis. CellEvent™ Caspase-3/7 Green Detection Reagent is a four-amino acid peptide (DEVD) conjugated to a nucleic acid-binding dye with absorption maximum of approx. 502-nm and emission maximum of approx. 530-nm. The peptide is a cleavage site for activated caspase-3/7, and the conjugated dye is non-fluorescent until cleaved from the peptide and bound to DNA (where the DEVD peptide inhibits binding of the dye to DNA).

Live cell imaging Time-lapse images were acquired with an inverted Leica DMi8 equipped with a Retiga R6 camera and Lumencor SOLA SE 365 light engine, using a 5X objective. The video-microscope was equipped with a motorized stage for multi-positioning acquisition, a CO₂ and temperature-controlled (37° C.) incubator chamber. All images were acquired with the same z-axis parameter but for each time point multiple x/y positions were acquired. In other words, all image data was 2D image data including multiple frames on the x-y plane. Since in the AIM-Biotech devices the gas-permeability is provided by the underside sealing layer, before inserting them on the microscope stage, the devices were placed on standard microscope glass slides and lifted with the help of magnet holders (1 mm thick), in order to create an air circulating space underneath the devices, for CO₂ and temperature control. The presence of a saturating humidity in the microscope chamber was crucial for optimal cell viability, therefore distilled water was added in the plastic wells of the DAX-1 chips and humidified small sponges were added in the chip surroundings. The acquisition of images in transmission and fluorescent channels was performed every hour for a total duration of 48 h to 72 h, depending on the experiment. The automated imaging system was controlled by the software Metamorph (Universal Imaging). The number of positions taken per chip was approximately 4 every hour. 3 to 12 gel/chip were imaged in parallel per experiment; in total, 12 to 48 x/y positions were imaged every hour. All images were acquired on a single z plane. However, z-stack acquisitions are possible within this set-up..

The STAMP method The STAMP (SpatioTemporal Apoptosis Mapper) software was developed in the MATLAB environment. The method was applied on each video V, with spatial dimensions D₁ (number of row) and D₂ (number of columns) and with a total duration of T frames (from 48 to 72 depending on experiments, with a frame rate of 1 hour).

Let us consider (x,y,t)∈{1..,D₁}×{1,..D₂}×{1,..T} the tuple indicating the position of the coordinates (x,y) occupied by an arbitrary pixel on the video frame of V acquired at time t, where t = 1, ..., T. In this context, V(x,y,t) indicates the video sequence with the specific coordinates (x,y)at time t. We can refer to the video under analysis indistinctly with V or V(x,y,t), comprising coordinates (x,y,t) ∈ {1, .., D₁}×{1, .. D₂}×{1, .. T}.

1. Cell localization and tracking. Tumor cells (stained in red) were located and tracked in the red channel video of V by adapting the CellHunter software to the frame rate of 1 hour [7,32,33]. The cells of interest (i.e. cells to be tracked) were stained prior to culturing with any other cells (i.e. in the present examples the cells to be tracked were pre-stained and any other cells were unstained). Localization was performed by preliminary binarizing the red channel video of V using the Otsu approach [34]. Briefly, the Otsu method identifies a threshold that can separate pixels into two classes (foreground, background), minimizing the intra-class variance (weighted sum of the variances of the two classes).

Then, Cell-Hunter was applied. Briefly, in each binarized video frame, the software implements a Circular Hough Transform (CHT) [35] (a well-known feature extraction technique used to detect circles in images by identifying the centre of circles of radius r) to automatically locate tumor cells, assumed as circular-shaped objects of a chosen radius, where the radius is chosen as providing an accurate estimate of individual cell radii. For example, a radius of 13 µm can be used in the present context. A suitable radius can be chosen heuristically by tuning the radius tolerance of the CHT then picking a radius that is close (in the present case, the closest integer value) to the mean value of all radii estimated by CHT. Cell trajectories/tracks were then constructed by linking positions between consecutive frames according to an optimized procedure based on the concept of cell proximity and optimal assignment problem, using the Munkres algorithm [36]. This can be performed, for example, as described in [37].

2. ROI extraction around each tumor cell. After tracking all the tumor cells in a video V, a square region of interest (ROI) of 31 pixels × 31 pixels (about 20 µm) was isolated, centred around each tumor cell position along each track. In this way, a square section “tube” (former by consecutive square sections over time) is constructed around each track. This procedure allows to confine the next analysis in the neighborhood of the tumor cells and to limit confounding factors in apoptosis analysis due to surrounding cells. In other words, the procedure for the ROI extraction allows localizing the extraction of the green signal around the cell, and the subtracting of the average background.

3. Background and foreground definition. Each ROI includes the cell (the foreground) and the background culture environment. To separate them, the tumor cell in the ROI is segmented using the CHT approach (as previously defined, i.e. the segmentation obtaine din step 1 is used), and a neighborhood circular region around the cell is defined by a given radius, here set to double the average radius of tumor cells (e.g. twice the average radius as identified by CHT in step 1). The use of twice the radius of the cell advantageously ensures that the cell is within the ROI even if localization errors occurred while reducing the amount of confounding structures in the neighbourhood. In the present case, the average radius was obtained as the average over all videos available for the cell population.

4. Time-dependent green emission (apoptosis) signal extraction. In order to extract the green emission signals of tumor cells (i.e. tumor apoptosis events), we transposed the tracked positions of tumor cells (i.e. the centres of the cell regions automatically detected by Cell-Hunter software) from the red to the green channel video.

Let us denote as (x_{tc}(t),y_{tc}(t)) ∈ {1,..,D₁}×(1,_{··}D₂} the pixel representing the position of the arbitrary tumor cell tc (i.e. centre of the tumor cell as identified by CHT in the tracking step) at time-frame t in the red and then green channel of video V, with t ∈ F ⊆{1,...,T}, where

$$F = \left\{{t}_{t c}^{s t a r t} , … , {t}_{t c}^{e n d}\right\}$$

is the set of time-frames for which the cell track constructed by Cell-Hunter exists. We can define:
I_{GREEN}(x,y,t), the intensity value of the pixel in position (x,y) on the video frame acquired at time t in the green emission channel, i.e., in the green channel video sequence of V(x,y,t), with (x,y,t) ∈ {1,..,D₁}×{1,..D₂}×{1,...,T},
R(x_{tc}(t), y_{tc}(t)), the squared ROI centred on the position (x_{tc}(t),y_{tc}(t)) of the tumor cell tc at time t, t ∈ F,
R_{B}(x_{tc}(t),y_{tc}(t)) and R_{F}(x_{tc}(t),y_{tc}(t)), the circular background (circular region around the cell, with a radius twoce the average radius of tumor cells) and the circular foreground (as determined by CHT) regions within the ROI R, respectively, both centred on the position of the same tumor cell tc at the same time t, t ∈ F.
Moreover, if R̅x_{tc}(t),y_{tc}(t)) is a generic ROI centred on (x_{tc}(t),y_{tc}(t)), i.e. R̅ = R V R_{B} V R_{F} for t ∈ F (i.e. R̅ refers to any of R, R_{B} or R_{F}, all of which are centred on a tumor cell), and (x,y) is a pixel on the video frame acquired at time t in the green channel belonging to the ROI R̅(x_{tc}(t), y_{tc}(t)), we can write (x,y)∈ R̅(x_{tc}(t), y_{tc}(t)) to refer to any pixel at time t in the ROI.

In order to capture the information content of the green emission in the tumor cell tc at a time t ∈ F, we proceed as follows:
4-i Compute the average green emission signal in the foreground region R_{F}(x_{tc}(t),y_{tc}(t)), expressed by
$$\begin{matrix}{μ}_{t c}^{{R}_{F}} \left(t\right) = \\ \frac{1}{A r e a \left({R}_{F} \left({x}_{t c} \left(t\right) , {y}_{t c} \left(t\right)\right)\right)} {\sum }_{\left(x , y\right) ∈ {R}_{F} \left({x}_{t c} \left(t\right) , {y}_{t c} \left(t\right)\right)} {I}_{G R E E N} \left(x , y , t\right) .\end{matrix} \qquad \text{(1)}$$
4-ii Compute the average green emission signal in the local background R_{B}(x_{tc}(t),y_{tc}(t)), that is
$$\begin{matrix}{μ}_{t c}^{{R}_{B}} \left(t\right) = \\ \frac{1}{A r e a \left({R}_{B} \left({x}_{t c} \left(t\right) , {y}_{t c} \left(t\right)\right)\right)} {\sum }_{\left(x , y\right) ∈ {R}_{B} \left({x}_{t c} \left(t\right) , {y}_{t c} \left(t\right)\right)} {I}_{G R E E N} \left(x , y , t\right) .\end{matrix} \qquad \text{(2)}$$
4-iii Perform background subtraction and normalization correction in order to avoid misleading surrounding green emission, thus obtaining µ_{tc}(t) as follows:
$${μ}_{t c} \left(t\right) = \frac{{μ}_{t c}^{{R}_{F}} \left(t\right) - {μ}_{t c}^{{R}_{B}} \left(t\right)}{{μ}_{t c}^{{R}_{B}} \left(t\right)} - {min}_{\hat{t} ∈ F} \left(\frac{{μ}_{t c}^{{R}_{F}} \left(\hat{t}\right) - {μ}_{t c}^{{R}_{B}} \left(\hat{t}\right)}{{μ}_{t c}^{{R}_{B}} \left(\hat{t}\right)}\right) . \qquad \text{(3)}$$

By computing µ_{tc}(t) for each t ∈ F, the time-depending signal µ_{tc} referred to the track of the tumor cell tc is produced. The higher the signal is the higher is the green emission of the cell region, and the higher the probability that an apoptosis event has occurred in the tracked cell.

5. Detection of the beginning of the apoptosis events. Let us assume N, the total number of detected tumor cells along the entire duration of the video V. From step 4, N time-dependent signals µ_{tc}, were computed, one for each of tumor cells denoted as tc. A threshold value th was estimated as the optimal inter-variance separation value of all the N signals µ_{tc}, (using the Otsu approach, i.e. identifying the threshold that when applied to µ_{tc}, separates the values into two classes that have the minimum intra-class variance, which is equivalent to the maximum inter-class variance) [34]. For each tumor cell tc, we consider that the death by apoptosis occurs if µ_{tc}, > th and that apoptosis begins at the time-frame at which the µ_{c} exceeds the value th for the first time:

$${T}_{t c}^{d e a t h} = {min}_{t} \left\{t ∈ F \vert {μ}_{t c} \left(t\right) > t h\right\} \qquad \text{(4)}$$

This approach is particularly advantageous to monitor the occurrence of an event associated with a signal that is produced when the event occurs, even if the signal fades thereafter. For example, the apoptosis signal used in this work only lasts few hours, and cannot be used as an endpoint measurement.

6. Counting the apoptotic events. In order to count the apoptotic events, we have to move from a tumor cell-centric view, used in depicting Steps 2-5, to a time-centric view. So, for each t ∈ {1,..., T}, the approach below is followed:

6-i Compute the number of apoptosis at time-frame t, Nₐₚ(t,T_{LAG}), which sum up the number of apoptosis events found in the range [t - T_{LAG},t] as the cumulative number of tracks of tumor cells tc whose signal µ_{tc}, satisfies the condition µ_{tc}(t) > th, for all t ∈ [t - T_{LAG},t] (i.e. at any t in [t - T_{LAG}, t] - in other words any track that has a green signal exceeding the threshold at any time t in the interval will be counted by counting the track as apoptotic for that time t, then the instantaneous values are summed to obtain Nap). Therefore, Nₐₚ(t,T_{LAG}) quantifies the number of tracks that showed signs of apoptosis having occurred at any time in an interval (T_{LAG}) preceding t, i.e. cells that died in that interval of time.

6-ii Compute the number of tracks of living cells at time-frame t, N_{track}(t), as the number of tracks at time t that did not yet go into apoptosis, i.e. the number of tracks whose µ_{tc} at time t satisfies the condition µ_{tc}(t) < th. A cell track that has been identified as having undergone apoptosis (i.e. cells that were positive for the apoptotic report, µ_{tc}(t) > th) at any time point t that precedes (up to an including t) are excluded from this count.

6-iii Compute the average number of tracks found in a temporal lag of T_{LAG} frames, N_{avg}(t,T_{LAG}), as the average of N_{track}(t) in the range [t -T_{LAG},t]. The value of T_{LAG} was defined in the order of a few hours (2-10 hrs) according to the desired temporal resolution and heuristic investigation (see Discussion). This value will be used to compute the “apoptosis rate” - step 6-iv - which compares the number of apoptosis events that occurred in the time interval T_{LAG} to the number of cells alive at the beginning of the interval. While strictly speaking the latter corresponds to N_{track}(t) at t=t-T_{LAG}, the use of the average of N_{track}(t) was found to be more consistent (with less fluctuations and errors linked to the instantaneous values of the tracks of the living cells). AS such, this was used as a more reliable estimate of the number of live cells at the beginning of the time interval T_{LAG}.

6-iv Compute the percentage of apoptotic events in T_{LAG} frames, O(t,T_{LAG}) (also referred to herein as the “apoptosis rate”), as

$$O \left(t , {T}_{L A G}\right) = \frac{{N}_{a p} \left(t , {T}_{L A G}\right)}{{N}_{a v g} \left(t , {T}_{L A G}\right)} ⋅ 100 \% \qquad \text{(5)}$$

In the present work, the number of frames to be included in TLAG was arbitrarily chosen as 7(i.e. T_{LAG}=7) . As the videos contained 49 frames, this led to 7 values per video. The use of a time interval T_{LAG} resulted in a more reliable estimate of the apoptosis rate, compared to instantaneous values. Indeed, the instantaneous number of tracks fluctuated a bit and the calculation of the % of apoptotic events in T_{LAG} frames was found to be more consistent (respect to the calculation per each time point).

6-v Compute the average of surviving cells in each time point N_{avg2}(t,t_{±1}), between 3 time points centered on t, as the average of N_{track}(t) in the range t_{±1} = [t₋₁ - t_{+1]}.

6-vi Compute the percentage of surviving cells, 0S(t,t_{±1}) (also referred as “overall survival”), as

$$O S \left(t , {t}_{\pm 1}\right) = \frac{{N}_{a v g 2} \left(t , {t}_{\pm 1}\right)}{{N}_{a v g 2} \left(t , {t}_{1} - {t}_{3}\right)} ⋅ 100 \%$$

Where t₁ and t₃ are the first and third time points.

7. Construction of spatial-temporal maps of apoptotic events. Using the information of death of each single tumor cell tc (namely, position, (x_{tc}(t),y_{tc}(t)) for each t ∈ F and timing of the apoptotic event,

$$\left({T}_{t c}^{d e a t h}\right)$$

a spatial-temporal map of death is constructed using the following procedure:

7-i An artificial video with the same spatial and temporal dimensions as video V, (D₁,D₂,T, respectively), is generated, which is denoted MD(x,y,t), with (x,y,t) ∈ {1,..,D₁}×{1,..D₂}×{1,..T} (see FIG. 2, top row). The artificial video MD(x,y,t) is generated such that, for each tumor cell tc, at frame

$$t = {T}_{t c}^{d e a t h} ,$$

the cell region, assumed as a circular region centred at the position

$$\left({x}_{t c} \left({T}_{t c}^{d e a t h}\right) , {y}_{t c} \left({T}_{t c}^{d e a t h}\right)\right)$$

(as determined in step 1), is labelled with white pixels, i.e., with pixel intensity values equal to 1. This allows to artificially reproduce the cell region of each tumor cell tc at its time of death,

$${T}_{t c}^{d e a t h} .$$

7-ii Assuming that a spatial-temporal signaling of death is produced by cells going into apoptosis, a new artificial video, M(x,y,t), is constructed according to an iterative approach, expressed by

$$M \left(x , y , t\right) = {Ψ}_{E}^{B} \left(M \left(x , y , t - 1\right)\right) + M D \left(x , y , t\right) , \qquad \text{(6)}$$

with(x,y,t) ∈ {1,..,D₁}×{1,..D₂} ×{2,..T}, and M(x,y,1) = MD(x,y,1) (see FIG. 2, second row).

The operator

$${Ψ}_{E}^{B}$$

denotes the gray-scale morphological erosion operator [33], with structure element B, defined as

$${Ψ}_{E}^{B} \left(\left(M \left(x , y , t\right)\right)\right) ≜ {min}_{\left({x}^{′} , {y}^{′}\right) ∈ B} \left\{M \left(x + {x}^{′} , y + {y}^{′} , t\right)\right\} . \qquad \text{(7)}$$

It is the extended binary erosion operator defined on gray-scale intensity matrices (although in this implementation the MD video is binary and so is the M video, this operator can be used also in gray-scale settings). The global effect of the

$${Ψ}_{E}^{B}$$

operator is to reduce the area occupied by each white object in the processed frame thus implementing a vanishing signaling referred to herein as a “death wake” (see death signaling modeling step in FIG. 1).

To apply the operator

$${Ψ}_{E}^{B} ,$$

in the present work, a circular structure element with radius r was used, i.e., Bᵣ defined as

$${B}_{r} ≜ \left\{\left(x , y\right) \vert {x}^{2} + {y}^{2} \leq r\right\} \qquad \text{(8)}$$

where the parameter r is defined as one third of the estimated average cell radius in the experiment. The choice of r depends on the need to simulate a wake with a reasonable duration with respect to the timing of the experiments (see Discussion).

The constructed artificial video M(x,y,t) takes into account the death wakes of cells enabling to cumulate the death signaling in a given region.

The wake region is located in each frame in which it exists at the location of the cell in the track in said frame.

7-iii We combined in a unique index both spatial and temporal death influence. First, given a temporal windowing of size T̃, we designed the cumulative map MC defined as

$$M C \left(x , y , t , \tilde{T}\right) = \sqrt{{\sum }_{{t}^{′} = t}^{t + \tilde{T}} {\left(M \left(x , y , {t}^{′}\right)\right)}^{2}} , \qquad \text{(9)}$$

with (x,y,t) ∈ {1,..,D₁}×{1,..D₂}×{1,..T-T̃} (see FIG. 2, third row). The cumulative map allows to aggregate the death events and their wakes over a given temporal interval equal to T̃, whose value needs to be optimized (see Discussion). The sum of values can be used insetad of the sum of square of values. The use of the sum of square of values was found to be a particularly robust way to combine the information over the interval. Then, to account for spatial influence (i.e., to discriminate randomly versus deterministically spatially distributed deaths) we defined a potential of death induction (see FIG. 2, bottom row).

Let us consider the temporal map (x,y,t,T̃) . Thanks to the fact that cell death is almost a sparse phenomenon, most part of the map MC is null. Hence, it is possible to define a generic object s(t) at frame t as a region of the map MC at time t that is not connected with other non-null region, and indicate with S(t) the set of not connected objects,

$$S \left(t\right) ≜ \left\{{s}_{i} \left(t\right) \vert {s}_{i} \left(t\right) ∩ {s}_{j} \left(t\right) = ∅ , i \neq j\right\} . \qquad \text{(10)}$$

Connection is defined under the 8-connectivity criterion [33] (where a pixel is an 8-neighbour of a given pixel if the two pixels either share an edge or a vertex). Under these assumptions, for each t ∈ {1,..T- T̃}, the potential of death induction is defined as follows (see FIG. 2, bottom plot):

$$\begin{matrix}{P}_{d e a t h} \left(t , \tilde{T}\right) ≜ \\ \frac{1}{2 \left|S \left(t\right)\right|} {\sum }_{i = 1}^{\left|S \left(t\right)\right|} {\sum }_{j = i + 1}^{\left|S \left(t\right)\right|} \frac{{\text{mean}}_{\left(x , y\right) ∈ {s}_{i} \left(t\right)} M C \left(x , y , t , \tilde{T}\right) + {\text{mean}}_{\left(x , y\right) ∈ {s}_{j} \left(t\right)} M C \left(x , y , t , \tilde{T}\right)}{\overline{d} \left({s}_{i} \left(t\right) , {s}_{j} \left(t\right)\right)} , \\ i \neq j\end{matrix} \qquad \text{(11)}$$

where |S(t)| denotes the number of elements in S and d̅(sᵢ(t),sⱼ(t)) denotes any distance operator between objects sᵢ(t) and sⱼ(t), normalized by the maximum dimension of the video frame (i.e. maximum between rows and columns of the frame). In this work, the Euclidean distance between the geometrical centre of the two objects was used, i.e., the average coordinates of their boundary.

In this work the Pdeath was calculated repeatedly over each map by cropping the map using a blocking procedure and calculating the Pdeath for each subregion. As a result, multiple values are obtained for each map, providing an indication of the variability (distribution) over the map. However, a single value of Pdeath may in principle ba calculated for each map or region of map.

Statistical analysis Statistical analysis and graphs were made with GraphPad Prism software (v7). Statistical threshold for significance was set for p values inferior to 0.05 after applying Mann-Whitney-Wilcoxon nonparametric test.

### Example 1: Development of a Method to Automatically Analyse Apoptotic Death

In order to generate 3D tumor-on-chip (ToC) co-cultures, we used commercially available microfluidic devices in plastic (AIM-Biotech), that were imaged under an inverted video-microscope with controlled CO₂ (5%) and temperature (37° C.) for 2-3 days. Cells were embedded in a 3D biomimetic collagen gel and injected in the 3.41 mm³ chamber of the microfluidic device.

For this work we generated mono-cultures (cancer cells only) and two kinds of bi-cultures (cancer cells with immune cells, cancer cells with CAFs). For all experiments, a live fluorescent dye (CellTrace, red) was used to selectively pre-stain the cancer cells before cultures on-chip, and a live fluorescent reporter for caspase activity (CellEvent Caspase-3/7, green) was added to on-chip culture medium to monitor apoptotic death. No matter the degree of co-culture complexity, the cancer death detection was achieved by monitoring the red to green signal transitions.

In order to automatically and objectively monitor, in time and in space, the events of apoptotic cancer cell deaths, i.e. the red to green signal transitions, we developed a computational strategy (FIG. 1, see Materials & Methods for details) named STAMP (from Spatiotemporal Apoptosis Mapping). Briefly, from multi-channel videos of ToC co-cultures, the cancer cells are localized and tracked in a first channel (the red channel in this example). The dying cancer cells are identified in the green channel, after signal normalization and thresholding. The death signal is modeled to vanish during T time frames. Then, the spatio-temporal features of all death signals are integrated in a unique map, from which a parameter, named potential of death induction (P_{death}), is computed over time.

Several output measurements were extracted and used for the following analysis. The first output of interest is the apoptotic rate, i.e. the percentage of cancer cells dying within a certain T_{LAG} time interval (4 to 10 hrs, in this study). This is calculated using the number of cells at the beginning of each time interval as starting reference. The use of a time window T_{LAG} helps to find a good compromise between measurement precision and temporal resolution. The second output of interest is the overall survival, i.e. the percentage of cancer cells alive over time. This is calculated using the number of cells at the beginning of the experiment as starting reference and therefore also takes into account cell proliferation. Examples 2 to 4 demonstrate the use of these outputs of the STAMP method. The third output of interest was the spatio-temporal map of death events, integrating the information of when and where all deaths occur. The fourth output of interest was the potential of death induction (P_{death}) within a time window T over the entire field of view and experimental time. This measures the capacity of dying cells to promote the death of nearby living cells in the 3D experimental setting. Example 5 demonstrates the use of the STAMP method to study the spatiotemporal features of apoptosis in cancer cell cultures exposed to drugs and autologous cytotoxic T cells.

In addition to the temporal kinetics, the STAMP method allows to extract the localization of dying cells, to build cumulative spatial maps of time-integrated death events, and to compute a potential of death induction (P_{death}) that quantifies the capability of dying cells to promote the death of nearby cells (see Material and Methods for mathematical details). The P_{death} (see Eq. (11)) combines in a unique parameter both spatial and temporal death induction effects. On one hand, the spatial distribution of regions with death events (dense or sparse) contributes to the final value of P_{death} thanks to the dependency on the inverse of the mutual distances. On the other hand, the average value of the cumulative map MC, that takes into account the effect of the death wake in the temporal window T̃, contributes to P_{death} thanks to the direct dependence on MC calculated for all paired death regions. On FIG. 2, we provide a simulated example for the P_{death} calculation, to qualitatively explain how this parameter integrates both spatial and temporal properties. To further explore the information contained in this parameter, simulations were performed with different spatiotemporal characteristics, as explained in Example 6.

### Example 2: Application to Quantify Chemotherapy-Mediated Cytotoxicity in Breast-Cancer-On-Chip Cultures

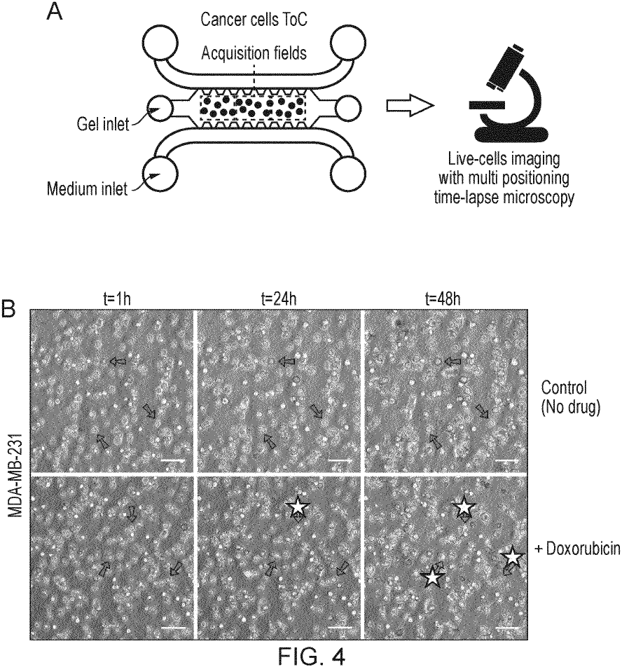

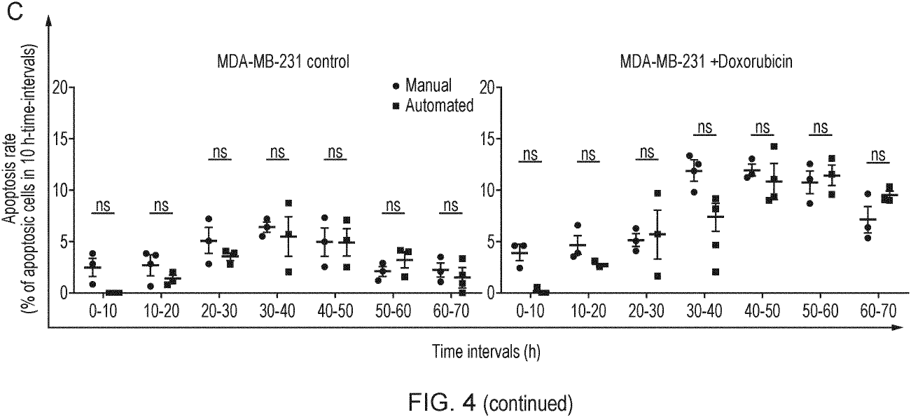

First, we applied the STAMP method to analyze the response of a standard cell model, the triple-negative breast cancer MDA-MB-231 cells, to a standard chemotherapy drug, doxorubicin (FIG. 4). To achieve a moderate killing, we chose a doxorubicin concentration of 1 µM, slightly lower than the IC50 of doxorubicin for MDA-MB-231 cells (2.8 µM), that we previously measured in standard 2D dishes.

In order to benchmark the accuracy of the automated method, we compared the values obtained by the algorithm with the values obtained by manual counting. The values closely matched for all the time points for all conditions (see FIG. 4C), we never found statistically significant differences between automated and manual counting, indicating that the algorithm is validated with respect to a standard human-controlled quantification method.

In control MDA-MB-231 cells without drug, the basal apoptosis rate in 10 hrs-time-intervals (T_{LAG} = 10 hrs) fluctuated around 5% during the experiment time (72 h), meaning that roughly 5% of the cells died in every 10 hrs period (see FIG. 4C, left). In doxorubicin-treated cells, the death rate remained at basal level during the first 20 hrs of treatment; only after 20 hrs of doxorubicin exposure the death rate increased up to more than 10% (see FIG. 4C, right). Therefore, the time-resolved STAMP analysis revealed that the speed of cytotoxic response to doxorubicin increases with the time in this 3D on-chip setting.

### Example 3: Application to Quantify T-Cell Mediated Cytotoxicity In Lung-Cancer-On-Chip Cultures

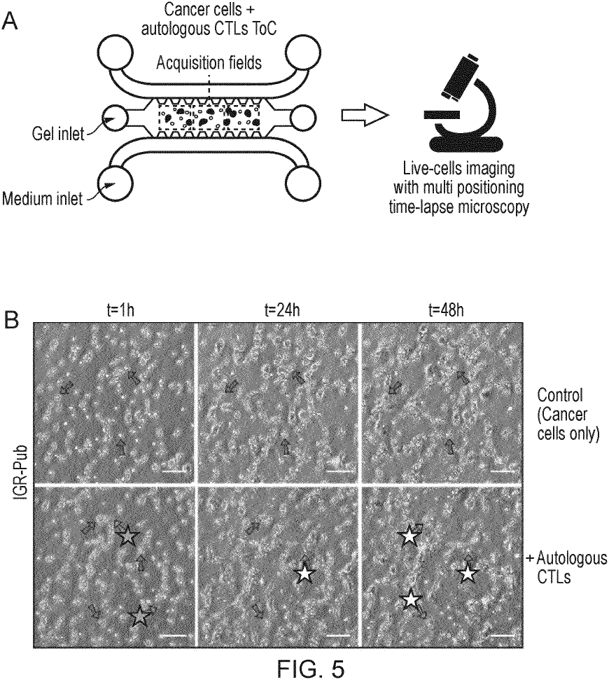

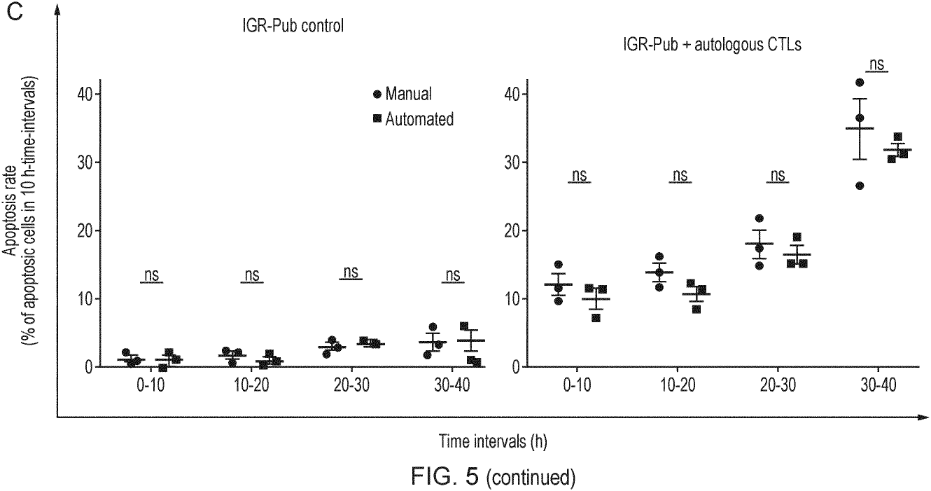

Next, we challenged the method with a more complex situation in which a non-small cell lung cancer (NSCLC) cell line (IGR-Pub ), was co-cultured with an autologous cytotoxic T lymphocyte clone (P62) that was generated from tumor-infiltrating lymphocytes (TIL) and selected to recognize and kill the cognate target [14] (see FIG. 5). To achieve a moderate killing, we chose a 1:1 cancer to T cell ratio (1:1 effector (CTL) to target (cancer) cell (E:T) ratio), which was in the same range of what observed in vivo in patients [15].

The algorithm could accurately distinguish the prestained cancer cells from the unstained T cells, and again the values obtained by the algorithm were not statistically different from the values obtained by manual counting (see FIG. 5C).

The basal apoptosis rate of IGR-Pub cells in 10 hrs-time-intervals (T_{LAG}= 10 hrs) was very low (around 2%) during the experiment time (48 h). The presence of the T cells immediately induced an important death (around 10%); after 30 hrs of co-cultures the apoptosis rate dramatically increased (up to 30%). Interestingly, similarly to what observed for cytotoxic response to doxorubicin (see FIG. 4C), the speed of cytotoxic response to cytotoxic T cells also appears to increase with time (see FIG. 5C, right).

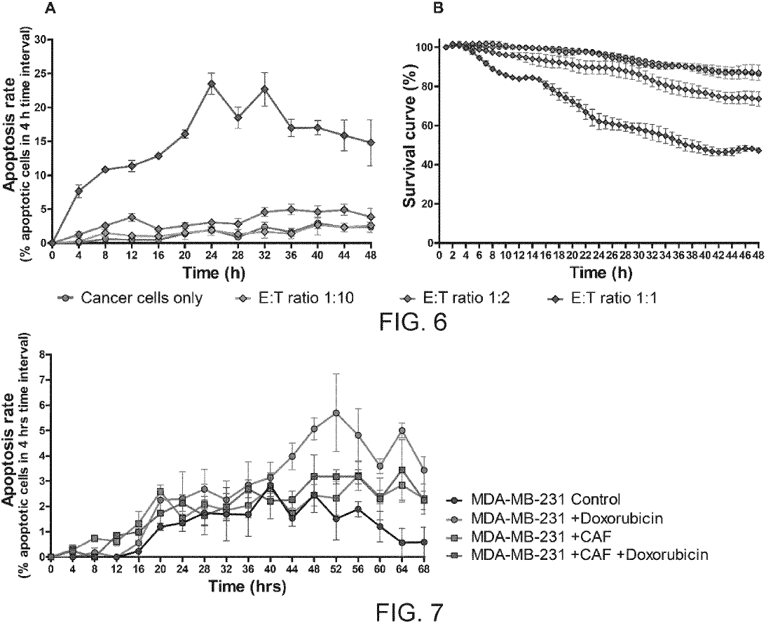

We further characterized the real-time dependency of T-cell mediated cytotoxicity on T cell density by using different E:T ratios with an increased time resolution (T_{LAG} = 4 hrs) (FIG. 6). At low T cell density (10:1 cancer:T cells ratio, 1:10 E:T ratio), the apoptosis rate was not different from the control without T cells. A mild killing started to appear at 2:1 cancer:T cells (1:2 E:T) ratio, but it is only at 1:1 cancer:T cells ratio that an efficient killing could be detected (FIG. 6A). Interestingly, there was not a linear proportionality between density and killing capacity of T cells, suggesting threshold effects. Again, the death rate increased with the time of co-cultures, despite the fact that after 2 days on chip the T cell viability was reduced (around 90 %).

Consistently, the overall survival curves of cancer cells, which takes into account the balance between cell death and cell proliferation (the on-chip IGR-Pub doubling time being approximatively 5 days), showed a detectable T-cell mediated cytotoxic effect only for the 1:2 E:T ratio and 1:1 E:T ratio (see FIG. 6B), with an approximatively 80% and 40% overall survival respectively after 48-hrs of co-culture.

### Example 4: Cancer-Associated Fibroblasts Promote Chemoresistance In Breast-Cancer-On-Chip

Having established that the STAMP method accurately monitors cancer death within co-cultures of cancer and T cells, we moved to bi-cultures of cancer cells and cancer-associated fibroblasts (CAFs). CAFs are a major component of the stroma which is crucial for tumor progression; in NSCLC tumor-stroma ratio could be used as prognostic factor for survival [23]. Since it is well established that CAFs contribute to chemoresistance in various cancer types [16-21], by co-culturing primary breast CAFs [8,22] with the breast cancer MDA-MB-231 cells, we assessed the capacity of ToC to recapitulate the CAF impact on doxorubicin resistance ex vivo. The addition of CAFs (6:1 cancer:CAF ratio) did not substantially alter the MDA-MB-231 apoptosis rate, however it completely impaired the doxorubicin-dependent apoptotic increase (as shown on FIG. 7).

These results indicate that ToC technology and STAMP quantifications will be very valuable to study the mechanisms underlying stroma contribution to cancer progression and to drug resistance.

### Example 5: Spatial-Temporal Analysis of Cytotoxic Death Reveals The Release Of Pro-Apoptotic Signals

In addition to the temporal kinetics of apoptosis, the STAMP method allows to extract the localization of dying cells, to build cumulative spatial maps of time-integrated death events, and to compute a potential of death induction (P_{death}) that quantifies the capability of dying cells to promote the death of nearby living cells (see Material and Methods for mathematical details).

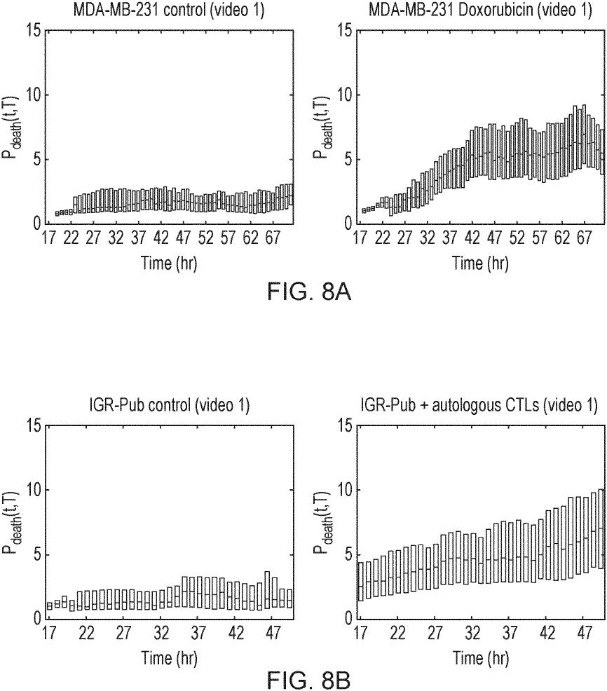

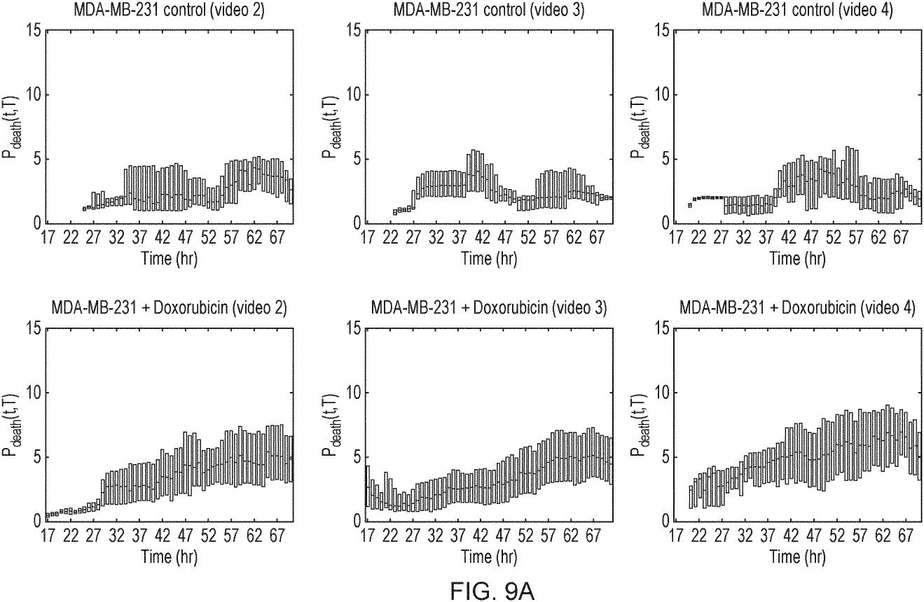

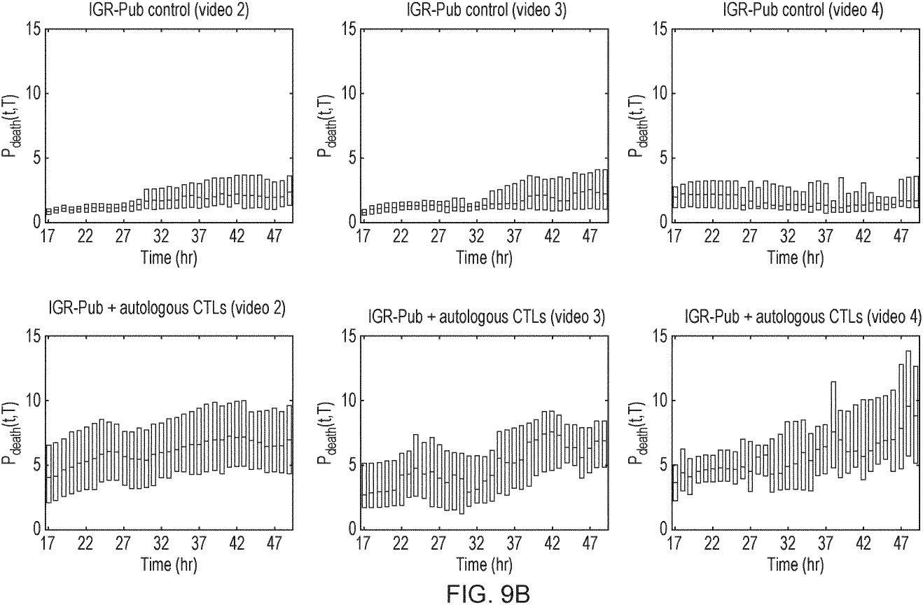

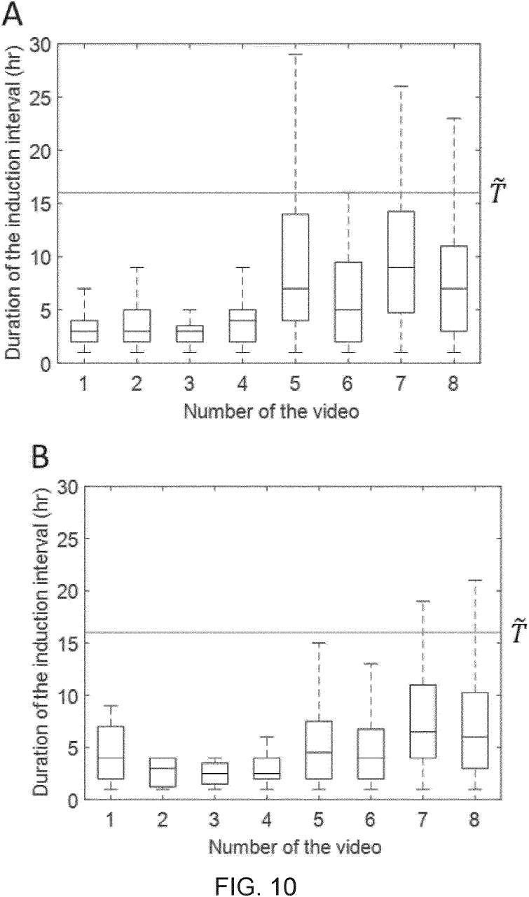

We computed P_{death} for the videos of both breast MDA-MB-231 and lung IGR-Pub cells (FIG. 8, FIGS. 9 and 10). In basal conditions, without drug or T cells, P_{death} is low for both cell types (< 0.1-0.2 ×10⁻³) and globally stable over the experimental time (2-3 days), meaning that naturally dying cancer cells do not have an impact on viability of nearby living cells. When cytotoxic death of MDA-MB-231 cells is induced with doxorubicin, P_{death} gradually increases up to 3-4 fold during the first 2 days, and remains high during the 3rd day, meaning that doxorubicin-dependent cytotoxic death actually promotes the death of nearby living cells. Similarly, when death of IGR-Pub cells is induced by autologous cytotoxic T cells, P_{death} is higher than the control without T cells from the start of co-cultures, and further increases during the 2-day experimental time, suggesting that T cell-dependent cytotoxic death promotes the death of nearby living cells as well. These results suggest the possibility that, contrary to naturally dying cancer cells, the cells that enter into apoptosis triggered by chemotherapy or T cells, send pro-apoptotic signals to neighboring cells, initiating a chain of death that amplifies the initial cytotoxic effect.

### Example 6: Simulations Showing the Dependency of the Potential Of Death Induction (P_{death}) on Temporal and Spatial Features

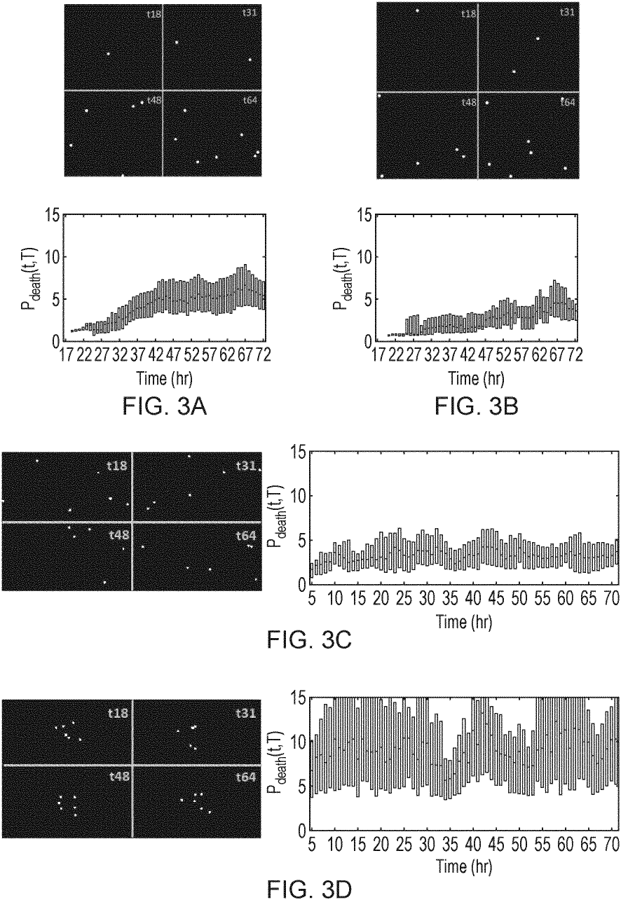

We generated three simulated artificial videos M(x,y,t) and quantified the corresponding P_{death} for each of these. Firstly, starting from a real example (FIG. 3A showing the spatial localization of death events at different time points (FIG. 3A top panel) - i.e. specific frames of the artificial video MC(x,y,t,T̃),, and the corresponding P_{death} measurements (FIG. 3A bottom panel) on a video of MDA-MB-231 cells treated with 1 µM doxorubicin), a simulated artificial video M(x,y,t) that had the same rate of death events as those in the real video (i.e. same number of events at same time) but with a spatially random distribution which maintained approximatively the relative distances between death objects (apoptosis events). The results of this simulation are shown on FIG. 3B, which shows that the corresponding P_{death} measurements are increasing much less than in FIG. 3A. This indicates that the P_{death} increase does not simply result from the increase of death numbers over time, but it depends also on death positions (i.e. which cells undergo apoptosis in which temporal order). Then, we generated a simulated artificial video M(x,y,t) with the same rate of death events but with a spatially random distribution. The results of this are shown on FIG. 3C, which shows that the corresponding P_{death} measurements are constant over time. Finally, we generated a simulated artificial video M(x,y,t) with the same rate of death events but with a spatially clustered distribution. The results of this are shown on FIG. 3D, which shows that the corresponding P_{death} measurements is much higher for the clustered deaths (FIG. 3D) than for the random deaths (on FIG. 3C). This shows that P_{death} increase does not simply result from the increase of death numbers over time, but it depends also on the death positions. In other words, the observed P_{death} kinetics depend on both temporal and spatial features.

### Discussion

We report here a new method, which extracts the temporal kinetics and the spatial maps of cancer death events within ToC co-cultures. The robustness and versatility of the method is demonstrated by its successful application to different cell models (breast and lung cancer), co-culture combinations (cancer cell alone, or together with T cells or CAFs), and experimental time-lapse acquisitions (frequency and duration). The STMAP image analysis method is likely to be useful for many other cellular contexts and biological questions, beyond the ToC technology. This adaptability to multiple experimental conditions is possible thanks to the integration within the STAMP software of three modular parameters.

First, the T_{LAG} mentioned in step 6-iii and used in Eq. (5) (see Material & Methods). T_{LAG} is the temporal window used to measure the average number of apoptotic events Nₐₚ(t,T_{LAG}) and the average number of living cells N_{avg}(t, T_{LAG}), allowing to compute the percentage of apoptosis events. T_{LAG} should be set depending on the time frame of image acquisition (image acquisition frequency) and on the desired time resolution of the investigated phenomenon. For example, the acquisition frequency being every 1 hour in this study, the choice of T_{LAG} value has a lower bound of 1 hour. However, T_{LAG} values larger than acquisition frequencies were more appropriate to avoid spurious fluctuations due to uncontrollable changes affecting the measurements (e.g., abrupt change in illumination). Conversely, T_{LAG} is also bounded above by the necessity to avoid flattening dynamic phenomena. We set T_{LAG} to 10 hours for FIGS. 4 and 5 whose purpose was the compare global accuracies, and to 4 hours for FIG. 6 whose purpose was to compare kinetics.

Second, the parameter r, in the morphological operator

$${Ψ}_{\text{E}}^{\text{B}}$$

(Eq. (7)) impacts on the death wake construction. In particular, starting from a circular object of radius r_{tc}, the effect of the application of the operator in Eq. (7) is to restrict the object radius of a quantity equal to r. Hence, by indicating with t₀ the time at which the cell tc dies and with t a generic time frame such that t > t₀, the radius vanishes according to the formula

$${r}_{t c} \left(t\right) = max \left(0 , {r}_{t c} \left({t}_{0}\right) - r ⋅ \left(t - {t}_{0}\right)\right)$$

By setting r as one third of r_{tc}, the equation can be re-written as

$$\begin{matrix}{r}_{t c} \left(t\right) = max \left(0 , {r}_{t c} \left({t}_{0}\right) - \frac{1}{3} {r}_{t c} \left({t}_{0}\right) ⋅ \left(t - {t}_{0}\right)\right) = \\ = max \left(0 , {r}_{t c} \left({t}_{0}\right) \left(1 - \frac{1}{3} \left(t - {t}_{0}\right)\right)\right) = max \left(0 , {r}_{t c} \left({t}_{0}\right) \left(1 - \frac{1}{3} Δ t\right)\right)\end{matrix}$$

where it can be noted that for at least three hours (Δt=3) the wake exists.

Third, the parameter T̃, in computation of MC (Eq. (9)) and of P_{death} (Eq. (11)). T̃ is the time window over which the aggregation of deaths and their wake were computed by means of the definition of cumulative map MC (Eq. (9)). Then, for each t E {1,..T -T̃}, the potential of death induction P_{death}(t,T̃) simultaneously measured the spatial and temporal death induction effects at time t. The value of T̃ has a key role in the quantification of death induction. A T̃ value that is too small results in under-detection of genuine death induction effects. A T̃ value that is too large causes a miss-leading flattening effect.

In this study, we set T̃ = 16 hr for both breast and lung cancer cells, based on the mathematical investigation of an induction interval that was associated to each cell and computed as follows. Let us consider a tumor cell tc centred in (x_{tc}(t),y_{tc}(t)) with radius r_{tc}(t) at the time of its death,

$$t = {T}_{t c}^{d e a t h} .$$

We assume that from its beginning at time

$$t = {T}_{t c}^{d e a t h} ,$$

the apoptosis of the cell tc induces some deaths and these deaths cause others and so on, by creating a chain of death started from the cell tc. We constructed this chain by involving deaths that occurred in a circular zone of radius equals to 10·r_{tc}(t), centred in (x_{tc}(t),y_{tc}(t)), at a temporal distance from each other equals to T_{LAG·} The total duration of the chain of death defines the induction interval related to the cell tc. The distributions of the duration of the induction intervals of cells from 16 videos from 2 experiments (FIG. 10), show that vast majority of induction intervals is below 16 hrs, meaning that T̃ = 16 permits to capture the vast majority of chain of death events.

Among the various types of cell death [24], this work specifically investigates the programmed apoptosis which involves the activation of the cascade of caspase enzymes. However, other types of cell death could be analysed, as well as any other biochemical activity that can be monitored by a reporter. Both cytotoxic stimuli we used are known to promote apoptosis of cancer cells. Doxorubicin have been shown to induce apoptosis on breast cancer cell lines in vitro [25], as well in breast cancer patients in vivo [26]. The cytotoxic T clone (P62) used is this work has been reported to kill autologous cells (IGR-Pub) at least in part via Apo2L/TRAIL-dependent apoptosis [14].

By using novel mathematical (e.g. Potential of death) and computational (STAMP software) strategies, we achieved an original spatiotemporal analysis of apoptotic cancer death in the 3D confined environments of ToC cultures. Surprisingly, contrary to naturally dying cancer cells, both doxorubicin-dependent and T cell-dependent cytotoxicity towards target cells promoted the death of nearby cancer cells, indicating that dying cancer cells might release soluble pro-apoptotic signals and trigger a chain of death that amplifies the initial cytotoxic stimulus.

Apoptotic cells do not passively empty their cellular content but they actively release various signals, termed “damage-associated molecular-pattern (DAMO) molecules” [38]. First, they release ‘find-me’ and ‘eat-me’ signals (such ATP and UTP nucleotides, the CX3CL1 chemokine, and the bioactive lipid metabolites lysophosphatidylcholine (LysoPC) and sphingosine-1-phosphate (S1P)), which enhance the attraction of phagocytes to dying cells and their consequent phagocytic clearance (a process called efferocytosis) [27]. Second, they send metabolite ‘good-bye’ signals with biological functions (such as AMP, GMP, creatine, spermidine, glycerol-3-phosphate (G3P), ATP), which act as tissue messengers altering gene expression of healthy nearby cells, for example suppressing inflammation [28]. Third, in the case of apoptotic cancer cells, they secrete cytokines/chemokines (such as IL-8, CCL2, CXCL1, CXCL2, CXCL5) that act as ‘immunomodulatory’ signals, promoting for example the polarization of monocytes to M2-like cells with consequent establishment of a tumor-supportive immune microenvironment [29].

Our findings indicate that apoptotic cancer cells further release unknown ‘pro-apoptotic’ signals that directly induce death of neighboring cells, without intervention of phagocytic macrophages, absent in our co-culture models. Identification of these compounds warrants more work. We estimated that the diffusion times of potential signaling molecules of various sizes (e.g., 100-500 Da for nucleotides, lipid metabolites, organic compounds or 10-20 kDa for cytokines), between cells with a distance in the 20-100 micron range, within the collagen gel (2.3 mg/mL), are very low, less than 10 minutes. Therefore, these diffusion times are fully compatible with the hypothesis of release of pro-apoptotic compounds from dying cells, triggering chains of deaths that last for 2-14 hours (see FIG. 10). Importantly, from developmental biology, we know that many secreted factors control apoptotic death events, spatially and temporally, to build multicellular organisms [30]. Pro-apoptotic compound candidates might be searched among these already known killers. However, at this stage we cannot exclude the implication of other processes in shaping the cytotoxic spatiotemporal behaviors. For example, the 20 h latency in the response to doxorubicin (FIG. 4C, right) might be caused by the necessity for cancer cells to enter DNA replication phase or by the time-dependent intracellular accumulation of this drug [39]. In lung cancer-T cell co-cultures, the late burst of death after 30 h of co-culture (FIG. 5C, right) might be due at least in part to a further activation of T cells upon co-culture with the target cells.

The phenomenon of ‘death transmissibility’ or ‘death contagiousness’ we unveiled in our ex vivo experimental setting might be linked to the well-known bystander effect observed in clinics [31]. Radiation-induced or chemotherapy-induced or immunotherapy-induced bystander effects refer to the induction of biological effects in cells that are not directly treated by radiation or chemotherapy or immunotherapy, but are in close proximity to cells that are. In our specific cases, all cancer cells are treated with doxorubicin or co-cultured with cytotoxic T cells, but the cells for which the treatments are effective have an indirect, unexpected, effect on the nearby cells.

In conclusion, this interdisciplinary work, by combining cancer biology, microfluidic engineering, mathematical modeling and computational analysis, created an innovative and needed image analysis method (STAMP), confirmed the power of ToC technology and shed a new light on the complexity of tumor ecosystem, emphasizing the intricacy of its non-autonomous cell behaviors.

### REFERENCES

1. Huh D, Kim HJ, Fraser JP, Shea DE, Khan M, Bahinski A, et al. Microfabrication of human organs-on-chips. Nat Protoc. 2013;8: 2135-2157. doi:10.1038/nprot.2013.137
2. van Duinen V, Trietsch SJ, Joore J, Vulto P, Hankemeier T. Microfluidic 3D cell culture: from tools to tissue models. Curr Opin Biotechnol. 2015;35: 118-126. doi:10.1016/j.copbio.2015.05.002
3. Osaki T, Sivathanu V, Kamm RD. Vascularized microfluidic organ-chips for drug screening, disease models and tissue engineering. Curr Opin Biotechnol. 2018;52: 116-123. doi:10.1016/j.copbio.2018.03.011
4. Sung KE, Beebe DJ. Microfluidic 3D models of cancer. Adv Drug Deliv Rev. 2014;79-80: 68-78. doi:10.1016/j.addr.2014.07.002
5. Boussommier-Calleja A, Li R, Chen MB, Wong SC, Kamm RD. Microfluidics: A new tool for modeling cancer-immune interactions. Trends Cancer. 2016;2: 6-19. doi:10.1016/j.trecan.2015.12.003
6. Sontheimer-Phelps A, Hassell BA, Ingber DE. Modelling cancer in microfluidic human organs-on-chips. Nat Rev Cancer. 2019;19: 65-81. doi:10.1038/s41568-018-0104-6
7. Nguyen M, De Ninno A, Mencattini A, Mermet-Meillon F, Fornabaio G, Evans SS, et al. Dissecting Effects of Anti-cancer Drugs and Cancer-Associated Fibroblasts by On-Chip Reconstitution of Immunocompetent Tumor Microenvironments. Cell Rep. 2018;25: 3884-3893.e3. doi:10.1016/j.celrep.2018.12.015
8. Pelon F, Bourachot B, Kieffer Y, Magagna I, Mermet-Meillon F, Bonnet I, et al. Cancer-associated fibroblast heterogeneity in axillary lymph nodes drives metastases in breast cancer through complementary mechanisms. Nat Commun. 2020;11: 404. doi:10.1038/s41467-019-14134-w
9. Crouch SP, Kozlowski R, Slater KJ, Fletcher J. The use of ATP bioluminescence as a measure of cell proliferation and cytotoxicity. J Immunol Methods. 1993;160: 81-88. doi:10.1016/0022-1759(93)90011-u
10. Thorn RM, Palmer JC, Manson LA. A simplified 51Cr-release assay for killer cells. J Immunol Methods. 1974;4: 301-315. doi:10.1016/0022-1759(74)90073-8
11. Forcina GC, Conlon M, Wells A, Cao JY, Dixon SJ. Systematic Quantification of Population Cell Death Kinetics in Mammalian Cells. Cell Syst. 2017;4: 600-610.e6. doi:10.1016/j.cels.2017.05.002
12. Fassy J, Tsalkitzi K, Goncalves-Maia M, Braud VM. A Real-Time Cytotoxicity Assay as an Alternative to the Standard Chromium-51 Release Assay for Measurement of Human NK and T Cell Cytotoxic Activity. Curr Protoc Immunol. 2017;118: 7.42.1-7.42.12. doi:10.1002/cpim.28
13. Park D, Son K, Hwang Y, Ko J, Lee Y, Doh J, et al. High-Throughput Microfluidic 3D Cytotoxicity Assay for Cancer Immunotherapy (CACI-IMPACT Platform). Front Immunol. 2019;10: 1133. doi:10.3389/fimmu.2019.01133
14. Dorothée G, Vergnon I, Menez J, Echchakir H, Grunenwald D, Kubin M, et al. Tumor-infiltrating CD4+ T lymphocytes express APO2 ligand (APO2L)/TRAIL upon specific stimulation with autologous lung carcinoma cells: role of IFN-alpha on APO2L/TRAIL expression and -mediated cytotoxicity. J Immunol Baltim Md 1950. 2002;169: 809-817.
15. Banat G-A, Tretyn A, Pullamsetti SS, Wilhelm J, Weigert A, Olesch C, et al. Immune and Inflammatory Cell Composition of Human Lung Cancer Stroma. PloS One. 2015;10: e0139073. doi:10.1371/journal.pone.0139073
16. Su S, Chen J, Yao H, Liu J, Yu S, Lao L, et al. CD10+GPR77+ Cancer-Associated Fibroblasts Promote Cancer Formation and Chemoresistance by Sustaining Cancer Stemness. Cell. 2018;172: 841-856.e16. doi:10.1016/j.cell.2018.01.009
17. Zhang D, Li L, Jiang H, Li Q, Wang-Gillam A, Yu J, et al. Tumor-Stroma IL1β-IRAK4 Feedforward Circuitry Drives Tumor Fibrosis, Chemoresistance, and Poor Prognosis in Pancreatic Cancer. Cancer Res. 2018;78: 1700-1712. doi:10.1158/0008-5472.CAN-17-1366
18. Cho J, Lee H-J, Hwang SJ, Min H-Y, Kang HN, Park A-Y, et al. The interplay between slow-cycling, chemoresistant cancer cells and fibroblasts creates a proinflammatory niche for tumor progression. Cancer Res. 2020 [cited 28 Mar. 2020]. doi:10.1158/0008-5472.CAN-19-0631
19. Duluc C, Moatassim-Billah S, Chalabi-Dchar M, Perraud A, Samain R, Breibach F, et al. Pharmacological targeting of the protein synthesis mTOR/4E-BP1 pathway in cancer-associated fibroblasts abrogates pancreatic tumour chemoresistance. EMBO Mol Med. 2015;7: 735-753. doi:10.15252/emmm.201404346
20. Leung CS, Yeung T-L, Yip K-P, Wong K-K, Ho SY, Mangala LS, et al. Cancer-associated fibroblasts regulate endothelial adhesion protein LPP to promote ovarian cancer chemoresistance. J Clin Invest. 128: 589-606. doi:10.1172/JCI95200
21. Ying L, Zhu Z, Xu Z, He T, Li E, Guo Z, et al. Cancer Associated Fibroblast-Derived Hepatocyte Growth Factor Inhibits the Paclitaxel-Induced Apoptosis of Lung Cancer A549 Cells by Up-Regulating the PI3K/Akt and GRP78 Signaling on a Microfluidic Platform. PLOS ONE. 2015;10: e0129593. doi:10.1371/journal.pone.0129593
22. Costa A, Kieffer Y, Scholer-Dahirel A, Pelon F, Bourachot B, Cardon M, et al. Fibroblast Heterogeneity and Immunosuppressive Environment in Human Breast Cancer. Cancer Cell. 2018;33: 463-479.e10. doi:10.1016/j.ccell.2018.01.011
23. Xi K-X, Wen Y-S, Zhu C-M, Yu X-Y, Qin R-Q, Zhang X-W, et al. Tumor-stroma ratio (TSR) in non-small cell lung cancer (NSCLC) patients after lung resection is a prognostic factor for survival. J Thorac Dis. 2017;9: 4017-4026. doi:10.21037/jtd.2017.09.29
24. Galluzzi L, Vitale I, Aaronson SA, Abrams JM, Adam D, Agostinis P, et al. Molecular mechanisms of cell death: recommendations of the Nomenclature Committee on Cell Death 2018. Cell Death Differ. 2018;25: 486-541. doi:10.1038/s41418-017-0012-4
25. Pilco-Ferreto N, Calaf GM. Influence of doxorubicin on apoptosis and oxidative stress in breast cancer cell lines. Int J Oncol. 2016;49: 753-762. doi:10.3892/ijo.2016.3558
26. Buchholz TA, Davis DW, McConkey DJ, Symmans WF, Valero V, Jhingran A, et al. Chemotherapy-induced apoptosis and Bcl-2 levels correlate with breast cancer response to chemotherapy. Cancer J Sudbury Mass. 2003;9: 33-41. doi:10.1097/00130404-200301000-00007
27. Elliott MR, Ravichandran KS. The Dynamics of Apoptotic Cell Clearance. Dev Cell. 2016;38: 147-160. doi:10.1016/j.devcel.2016.06.029
28. Medina CB, Mehrotra P, Arandjelovic S, Perry JSA, Guo Y, Morioka S, et al. Metabolites released from apoptotic cells act as tissue messengers. Nature. 2020;580: 130-135. doi:10.1038/s41586-020-2121-3
29. Hartwig T, Montinaro A, von Karstedt S, Sevko A, Surinova S, Chakravarthy A, et al. The TRAIL-Induced Cancer Secretome Promotes a Tumor-Supportive Immune Microenvironment via CCR2. Mol Cell. 2017;65: 730-742.e5. doi:10.1016/j.molcel.2017.01.021
30. Eroglu M, Derry WB. Your neighbours matter - non-autonomous control of apoptosis in development and disease. Cell Death Differ. 2016;23: 1110-1118. doi:10.1038/cdd.2016.41
31. Mothersill C, Rusin A, Fernandez-Palomo C, Seymour C. History of bystander effects research 1905-present; what is in a name? Int J Radiat Biol. 2018;94: 696-707. doi:10.1080/09553002.2017.1398436
32. Parlato S, De Ninno A, Molfetta R, Toschi E, Salerno D, Mencattini A, et al. 3D Microfluidic model for evaluating immunotherapy efficacy by tracking dendritic cell behaviour toward tumor cells. Sci Rep. 2017;7: 1093. doi:10.1038/s41598-017-01013-x
33. Di Giuseppe D, Corsi F, Mencattini A, Comes MC, Casti P, Di Natale C, et al. Learning Cancer-Related Drug Efficacy Exploiting Consensus in Coordinated Motility Within Cell Clusters. IEEE Trans Biomed Eng. 2019;66: 2882-2888. doi:10.1109/TBME.2019.2897825
34. Gonzales RC, Woods RE. Digital image processing. 2nd edition. Prentice Hall; 2002.
35. Davies ER. Machine Vision: Theory, Algorithms, Practicalities. 3rd Edition. Morgan Kauffman Publishers; 2005.
36. Munkres J. Algorithms for the assignment and transportation problems. J Soc Ind Appl Math. 1957;5: 32-38.
37. A. Mencattini, D. Di Giuseppe, M. C. Comes, P. Casti, F. Corsi, F. R. Bertani, L. Ghibelli, L. Businaro, C. Di Natale, M. C. Parrini & E. Martinelli. Discovering the hidden messages within cell trajectories using a deep learning approach for in vitro evaluation of cancer drug treatments. Scientific Reports volume 10, Article number: 7653 (2020).
38. Sangiuliano B, Pérez NM, Moreira DF, Belizário JE. Cell Death-Associated Molecular-Pattern Molecules: Inflammatory Signaling and Control. Mediators Inflamm. 2014;2014. doi:10.1155/2014/821043
39. Andreoni A, Colasanti A, Kisslinger A, Mastrocinque M, Riccio P, Roberti G. Fluorometric determination of the kinetics of anthracyclines uptake by cells. J Biochem Biophys Methods. 1994;28: 53-68. doi:10.1016/0165-022x(94)90064-7.

All references cited herein are incorporated herein by reference in their entirety and for all purposes to the same extent as if each individual publication or patent or patent application was specifically and individually indicated to be incorporated by reference in its entirety.

The terms “computer system” includes the hardware, software and data storage devices for embodying a system or carrying out a method according to the above described embodiments. For example, a computer system may comprise a central processing unit (CPU), input means, output means and data storage, which may be embodied as one or more connected computing devices. Preferably the computer system has a display or comprises a computing device that has a display to provide a visual output display. The data storage may comprise RAM, disk drives or other computer readable media. The computer system may include a plurality of computing devices connected by a network and able to communicate with each other over that network.

The methods of the above embodiments may be provided as computer programs or as computer program products or computer readable media carrying a computer program which is arranged, when run on a computer, to perform the method(s) described above.

The term “computer readable medium/media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

Unless context dictates otherwise, the descriptions and definitions of the features set out above are not limited to any particular aspect or embodiment of the invention and apply equally to all aspects and embodiments which are described.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

It must be noted that, as used in the specification and the appended claims, the singular forms “a,” “an,” and “the” include plural referents unless the context clearly dictates otherwise. Ranges may be expressed herein as from “about” (or “approximately”) one particular value, and/or to “about” another particular value. When such a range is expressed, another embodiment includes from the one particular value and/or to the other particular value. Similarly, when values are expressed as approximations, by the use of the antecedent “about” or “approximately”, it will be understood that the particular value forms another embodiment. The terms “about” and “approximately” in relation to a numerical value is optional and means for example +/- 10%.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

Other aspects and embodiments of the invention provide the aspects and embodiments described above with the term “comprising” replaced by the term “consisting of” or “consisting essentially of”, unless the context dictates otherwise.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organisational purposes only and are not to be construed as limiting the subject matter described.

1. A computer-implemented method of analysing cell culture image data, the method comprising:
accessing image data comprising a set of images (V(x,y,t)) of a cell culture at a plurality of consecutive time points (t = 1, ..., T), wherein the image data comprises a first signal associated with the presence of cells and a second signal associated with the occurrence of a cellular event;
using an image analysis algorithm to determine the position of cells in at least a first population of cells ((x_{tc}(t),y_{tc}(t)), from the first signal, in each of the images (V(x,y,t));
linking at least some of the positions of cells in the images into respective cell tracks, wherein a cell track identifies the position of a single cell
$$\left(\left({x}_{t c} \left(t\right) , {y}_{t c} \left(t\right) , t = \left\{{t}_{t c}^{s t a r t} , … , {t}_{t c}^{e n d}\right\}\right)\right)$$
in a plurality of consecutive images
$$\left(V \left(x , y , t\right) , t = \left\{{t}_{t c}^{s t a r t} , … , {t}_{t c}^{e n d}\right\}\right)$$
of the set of images;
identifying the timing
$$\left({T}_{t c}^{d e a t h}\right)$$
and position
$$\left({x}_{t c} \left({T}_{t c}^{d e a t h}\right) , {y}_{t c} \left({T}_{t c}^{d e a t h}\right)\right)$$
of occurrence of a cellular event in each of a plurality of cell tracks by:
(i) quantifying the second signal associated with the cell (µ_{tc}(t)) in each image in which the respective cell track is present;
(ii) obtaining a criterion that applies to the values in (i) and is associated with the occurrence of the cellular event; and
(iii) identify the timing
$$\left({T}_{t c}^{d e a t h}\right)$$
of occurrence of the cellular event in each of the plurality of cell tracks as the time associated with the first image in the respective track where the value obtained in (i) satisfies the criterion in (ii), and the position
$$\left({x}_{t c} \left({T}_{t c}^{d e a t h}\right) , {y}_{t c} \left({T}_{t c}^{d e a t h}\right)\right)$$
of occurrence of the cellular event as the position
$$\left({x}_{t c} \left({T}_{t c}^{d e a t h}\right) , {y}_{t c} \left({T}_{t c}^{d e a t h}\right)\right)$$
of the cell at the time of occurrence of the cellular event.

2. The method of claim 1, further comprising generating an artificial set of images (MD(x,y,t)) of the cell culture at the plurality of consecutive time points (t= 1, ..., T) by, for each occurrence of the cellular event identified in step (iii), defining an event region associated with the position
$$\left({x}_{t c} \left({T}_{t c}^{d e a t h}\right) , {y}_{t c} \left({T}_{t c}^{d e a t h}\right)\right)$$
on the image
$$M D \left(x , y , {T}_{t c}^{d e a t h}\right) ,$$
wherein the event regions have a different pixel intensity from the rest of the images.

3. The method of claim 2, wherein generating an artificial set of images (MD(x,y,t)) of the cell culture further comprises, for each event region in the artificial set of images (MD(x,y,t)), including an event wake region in a set of consecutive images following the image
$$\left(M D \left(x , y , {T}_{t c}^{d e a t h}\right)\right)$$
in which the event region is located, wherein an event wake region in image
$$M D \left(x , y , t ∈ \left\{{T}_{t c}^{d e a t h} + 1 , … , T\right\}\right)$$
is obtained using the event region in the preceding image
$$M D \left(x , y , t ∈ \left\{{T}_{t c}^{d e a t h} , … , T - 1\right\}\right)$$
.

4. The method of claim 3, wherein an event wake region in image
$$M D \left(x , y , t ∈ \left\{{T}_{t c}^{d e a t h} + 1 , … , T\right\}\right)$$
is obtained using the event region in the preceding image
$$M D \left(x , y , t ∈ \left\{{T}_{t c}^{d e a t h} , … , T - 1\right\}\right)$$
by applying an erosion operator to each image MD(x,y,t) where (x,y,t) ∈ {1,..,D
₁} × {1,..D₂} × {2,..T}.

5. The method of any of claims 2 to 4, further comprising generating one or more cumulative maps (MC(x,y,t,T̃)) that each aggregate the information in consecutive frames of the artificial set of images in a sliding window of size T̃ thereby generating an integrated event region corresponding to each area where an event or event wake was present at any point in time window T̃, optionally wherein each MC(x,y,t,T̃) is defined by
$$M C \left(x , y , t , \tilde{T}\right) = \sqrt{{\sum }_{{t}^{′} = t}^{t + \tilde{T}} {\left(M \left(x , y , {t}^{′}\right)\right)}^{2}} , \qquad \text{(9)}$$
with (x,y,t) ∈ {1,..,D
₁} × {1,..D₂} × {1,..T - T̃}.

6. The method of claim 5, further comprising computing for each cumulative map MC(x,y,t,T̃) or portion thereof, a potential of event induction that takes into account the intensity of each integrated event region in the cumulative map or portion thereof and the relative distances between event regions in the cumulative map, optionally wherein a potential of event induction is determined at least in part by:
identifying all non-connected integrated event regions in the cumulative map or portion thereof;
computing a summarized value of the signal in each non-connected integrated event region;
computing a distance between all pairs of non-connected integrated event regions; and
computing a summarized value for each pair of non-connected integrated event regions, wherein the summarized value for each pair of non-connected integrated event regions is proportional to the summarized values of the signal in both of the non-connected integrated event regions in the pair, and inversely proportional to the distance between the pair of non-connected integrated event regions.

7. The method of any preceding claim, wherein step (i) comprises identifying a foreground region (R_{F}(x_{tc}(t),y_{tc}(t))) and a background region (R_{B}(x_{tc}(t),y_{tc}(t))) associated with, such as e.g. centred around, each cell position in a respective track
$$\left(\left({x}_{t c} \left(t\right) , {y}_{t c} \left(t\right) , t =\right)\right) \left(\left\{{t}_{t c}^{s t a r t} , … , {t}_{t c}^{e n d}\right\}\right) ,$$
quantifying the second signal in the foreground region
$$\left({μ}_{t c}^{{R}_{F}} \left(t\right)\right)$$
and in the background region
$$\left({μ}_{t c}^{{R}_{B}} \left(t\right)\right) ,$$
and quantifying the second signal associated with the cell by performing background subtraction, optionally wherein quantifying the second signal in the foreground and the background region comprises obtaining a summarised metric for the second signal over the respective region.

8. The method of claim 7, wherein quantifying the second signal associated with the cell further comprises performing background normalisation.

9. The method of any preceding claim, wherein the first signal is associated with a first channel and the second signal is associated with a second channel, wherein the first and second channels are associated with different visualisation protocols, such as e.g. different detection wavelengths or sets of wavelengths.

10. The method of any of claims 7 to 9, wherein the foreground region (R_{F}(x_{tc}(t),y_{tc}(t))) and the background region (R_{B}(x_{tc}(t),y_{tc}(t))) are centred around each cell position in a respective track ((x_{tc}(t),y_{tc}(t),
$$t = \left(\left\{{t}_{t c}^{s t a r t} , … , {t}_{t c}^{e n d}\right\}\right) ,$$
optionally wherein the foreground region and the background region are both circular, preferably wherein the foreground and background regions have respective radii corresponding to the expected (e.g. average) radius of the cell and a multiple (e.g. double) the expected radius of the cell.

11. The method of any preceding claim, wherein step (ii) comprises identifying a threshold (th) that separates the values of the second signal for the cells between two classes such that the intra-class variance is minimised, and step (iii) comprises identifying the first image in the respective track where the value obtained in (i) is above the threshold.

12. The method of any preceding claim, further comprising computing the rate of occurrence of the cellular event at a time t by:
determining the number of tracked cells (Nₐₚ(t,T_{LAG})) for which the value obtained in (i) (µ_{tc}(t)) satisfies the criterion in (ii), at any of time t and times t in a preceding window of time (T_{LAG}); and
determining the number of tracked cells (N_{track}(t)) for which the value obtained in (i) at time t (µ_{tc}(t)) does not satisfy the criterion in (ii), optionally comprising determining N_{track}(t) for each time in the time window t ∈ [t - T_{LAG}, t], and computing a summarized metric (N_{avg}(t,T_{LAG})) of the values thus obtained, such as e.g. the average or median of the values thus obtained, preferably wherein N_{track}(t) excludes any tracked cell for which the value obtained in (i) (µ_{tc}(t)) satisfies the criterion in (ii) at any time preceding time t; and
comparing the values Nₐₚ(t,T_{LAG}) and N_{track}(t) or N_{avg}(t,T_{LAG}) to obtain a rate of occurrence of the cellular event (O(t,T_{LAG})), optionally wherein O(t,T_{LAG}) is calculated as
$$O \left(t , {T}_{L A G}\right) = \frac{{N}_{a p} \left(t , {T}_{L A G}\right)}{{N}_{a v g} \left(t , {T}_{L A G}\right)} ⋅ 100 \% .$$
.

13. A method of analysing the spatiotemporal behaviour of the occurrence of a cellular event in a cell culture, the method comprising:
obtaining image data comprising a set of images (V(x,y,t)) of the cell culture at a plurality of consecutive time points (t= 1,...,T), wherein the image data comprises a first signal associated with the presence of cells and a second signal associated with the occurrence of the cellular event; and
analysing the image data using the method of any of claims 1 to 12.

14. The method of any preceding claim, wherein the cells have been labelled with a first label that is associated with cells or cell structures and that is associated with the first signal, and a second label that is an event-triggered label and that is associated with the second signal, optionally wherein the first and/or the second label is/are fluorescent labels and/or wherein the cellular event is apoptosis, preferably wherein the second label is a label that emits a signal upon activation of Caspase-3/7.

15. A system for analysing cell culture image data, the system comprising:
at least one processor; and
at least one non-transitory computer readable medium containing instructions that, when executed by the at least one processor, cause the at least one processor to perform the method of any of claims 1 to 14.
